(19) United States
(12) Patent Application Publication
(10) Pub. No.: US 2017/0364860 A1
(43) Pub. Date: Dec. 21, 2017

(54) VECTOR-BASED CHARACTERIZATIONS OF PRODUCTS AND INDIVIDUALS WITH RESPECT TO PROCESSING RETURNS

(71) Applicant: Wal-Mart Stores, Inc., Bentonville, AR (US)

(72) Inventors: Bruce W. Wilkinson, Rogers, AR (US); Todd D. Mattingly, Bentonville, AR (US); Sai Phaneendra Sri Harsha Viswanath Putcha, Bentonville, AR (US)

(21) Appl. No.: 15/625,599

(22) Filed: Jun. 16, 2017

Related U.S. Application Data
(60) Provisional application No. 62/351,467, filed on Jun. 17, 2016.
(60) Provisional application No. 62/409,008, filed on Oct. 17, 2016.
(60) Provisional application No. 62/436,842, filed on Dec. 20, 2016.
(60) Provisional application No. 62/479,525, filed on Mar. 31, 2017.
(60) Provisional application No. 62/480,733, filed on Apr. 3, 2017.
(60) Provisional application No. 62/485,045, filed on Apr. 13, 2017.

(51) Int. Cl. G06Q 10/08; G06Q 30/02

(52) U.S. Cl. CPC G06Q 10/0837; G06Q 30/0255

(57) ABSTRACT

Systems, apparatuses, and methods are provided herein for processing returns. A system for processing returns, comprises a customer profile database, a communication device, and a control circuit. The control circuit being configured to: receive, via the communication device, information on a return item being returned by a first customer associated with a delivery agent, retrieve customer partiality vectors of a plurality of customers associated with the delivery agent from the customer profile database, select a second customer from the plurality of customers based on the partiality vectors of the second customer, and instruct the delivery agent to reroute the return item from the first customer to the second customer.

### RELATED APPLICATION(S)

This application claims the benefit of U.S. Provisional application No. 62/436,842, filed Dec. 20, 2016, U.S. Provisional application No. 62/485,045, filed Apr. 13, 2017, U.S. Provisional application No. 62/351,467, filed Jun. 17, 2016, U.S. Provisional application No. 62/480,733, filed Apr. 3, 2017, Provisional application No. 62/479,525, filed Mar. 31, 2017, and Provisional application No. 62/409,008, filed Oct. 17, 2016 which are all incorporated by reference in their entirety herein.

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 comprise a flow diagram as configured in accordance with various embodiments of these teachings;

FIG. 19 comprises a block diagram as configured in accordance with various embodiments of these teachings;

FIGS. 20A and 20B comprise illustrations of delivery routes in accordance with various embodiments of these teachings;

FIG. 21 comprises a block diagram as configured in accordance with various embodiments.

FIG. 22 comprises a block diagram as configured in accordance with various embodiments.

FIG. 23 comprises a flow diagram as configured in accordance with various embodiments;

FIG. 24 comprises a block diagram as configured in accordance with various embodiments of these teachings;

FIG. 25 comprises a flow diagram as configured in accordance with various embodiments of these teachings;

FIG. 26 comprises a flow diagram as configured in accordance with various embodiments of these teachings;

FIG. 27 comprises a block diagram as configured in accordance with various embodiments of these teachings;

FIG. 28 comprises a flow diagram as configured in accordance with various embodiments of these teachings;

FIG. 29 comprises a flow diagram as configured in accordance with various embodiments of these teachings; and

FIG. 30A and FIG. 30B comprise illustrations of a container as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

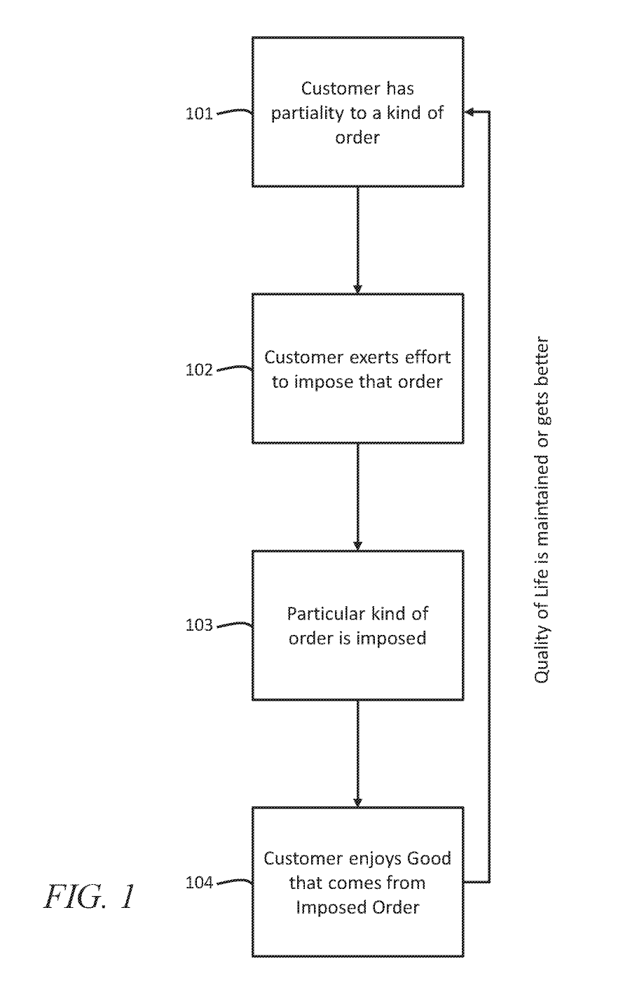

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

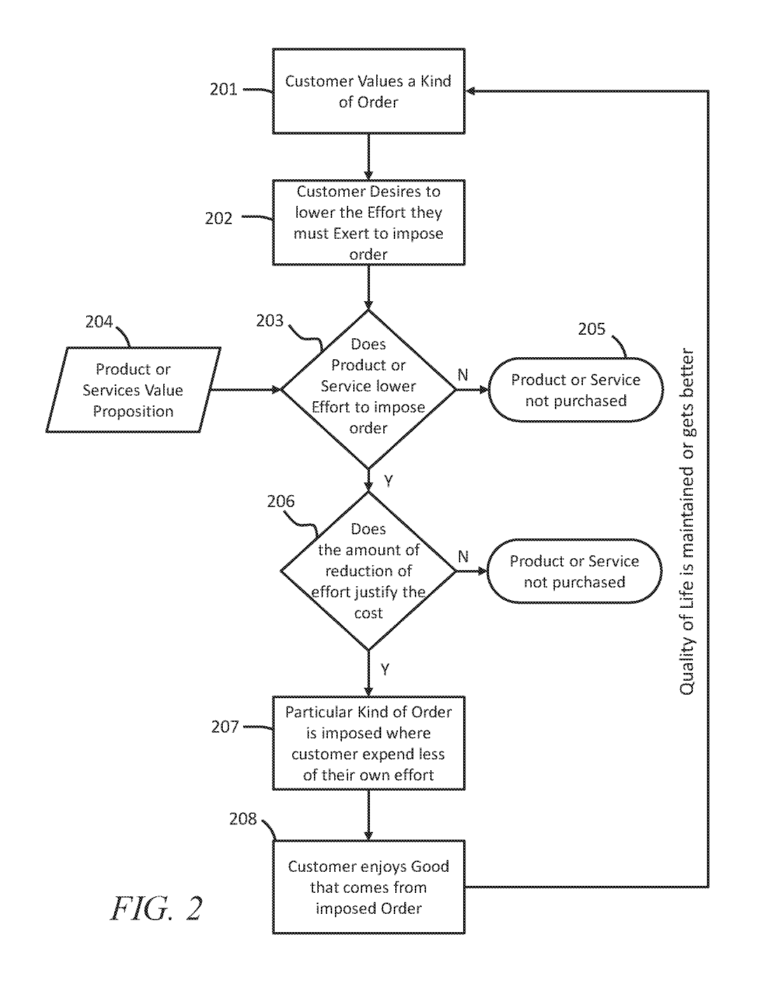

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

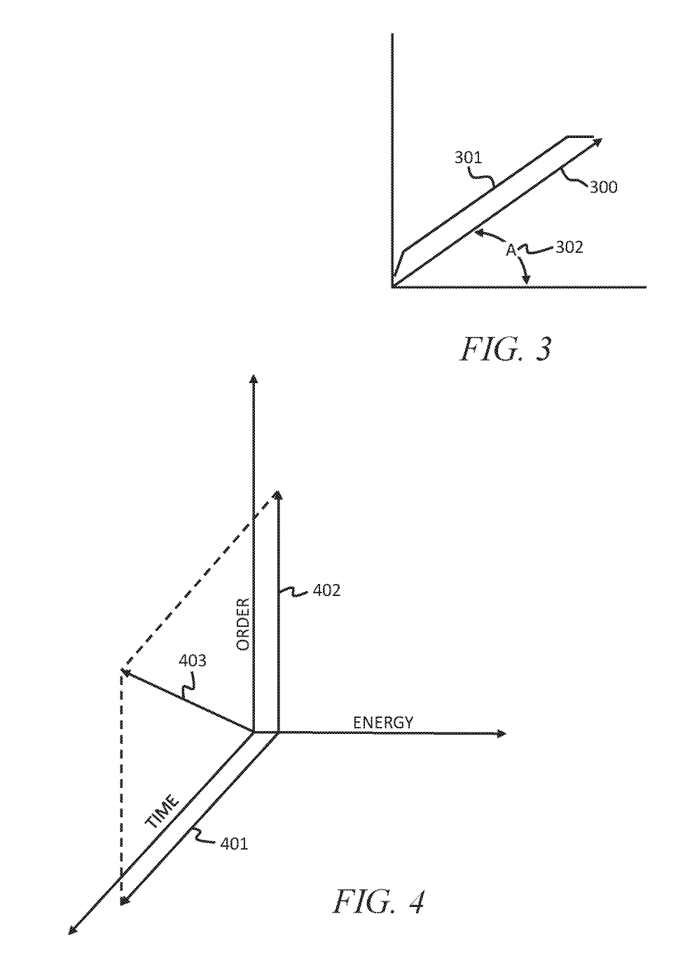

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

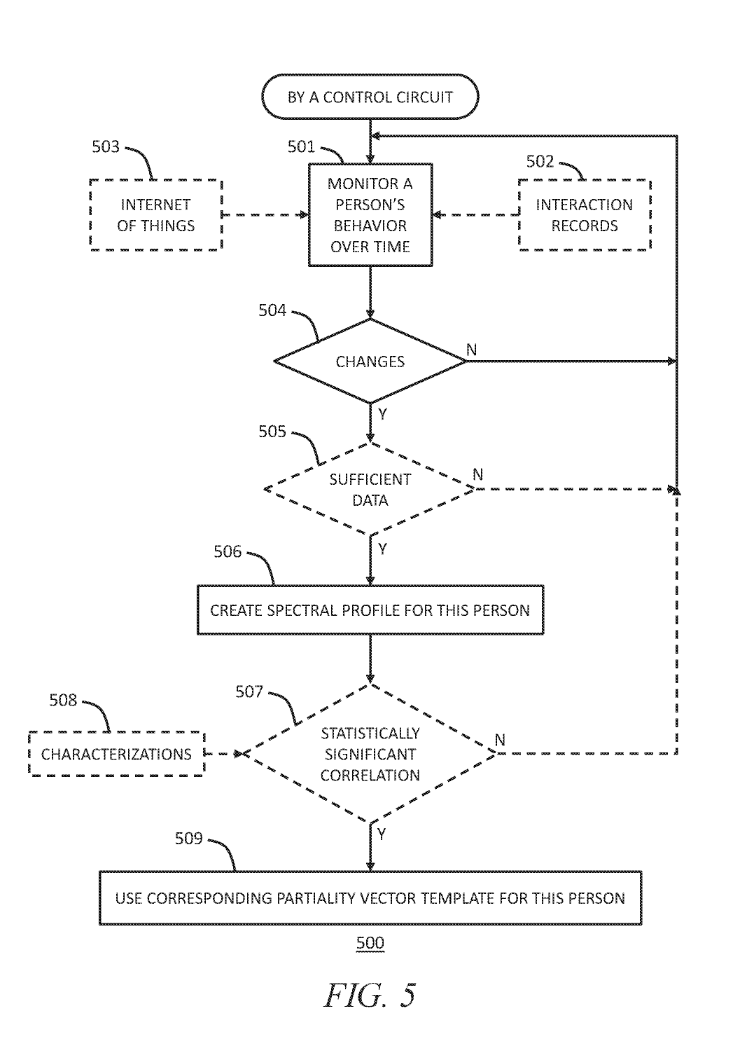

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

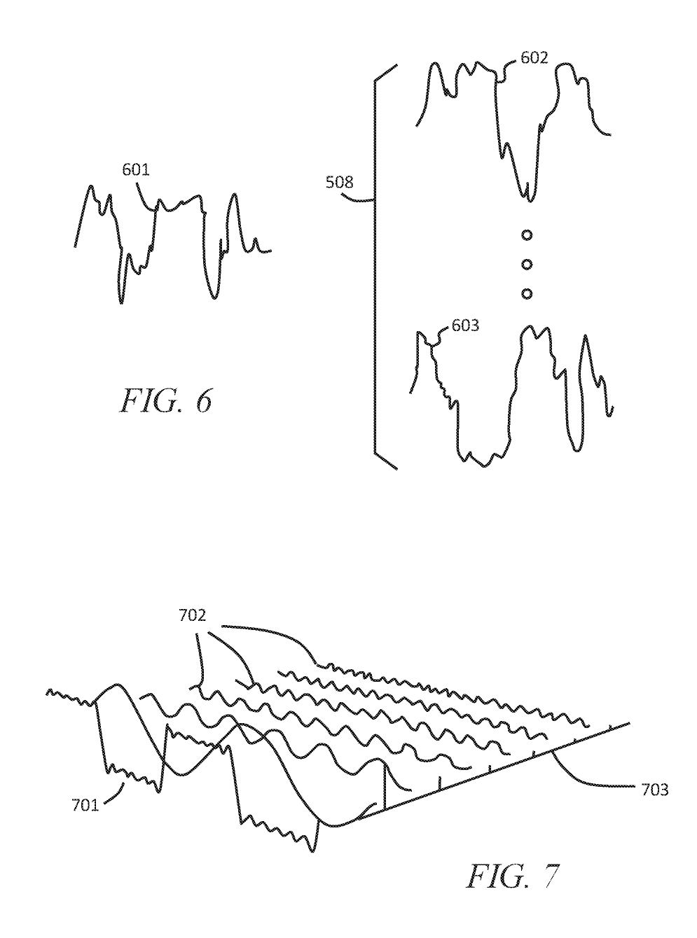

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

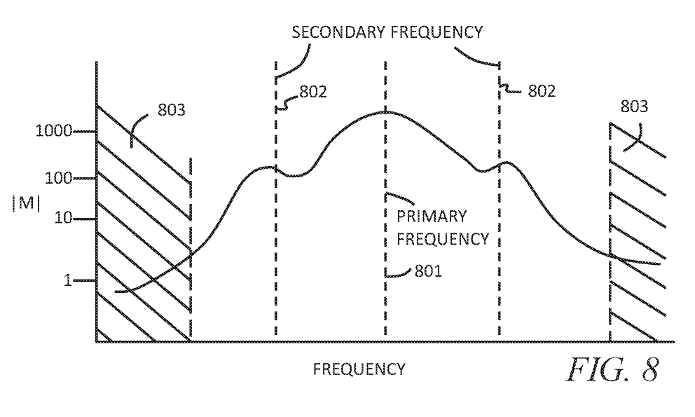

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

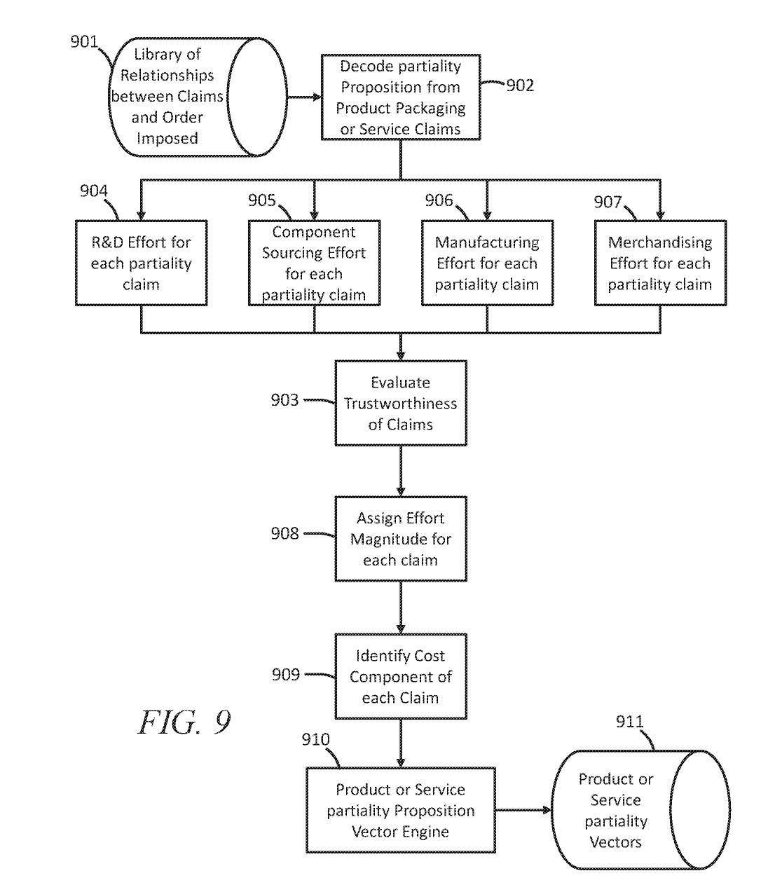

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

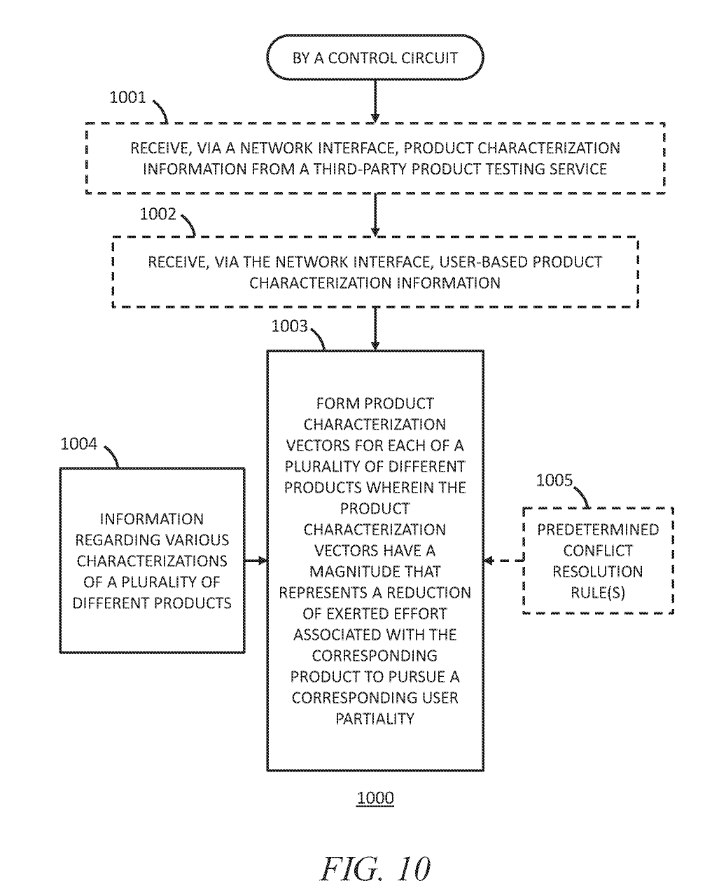

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

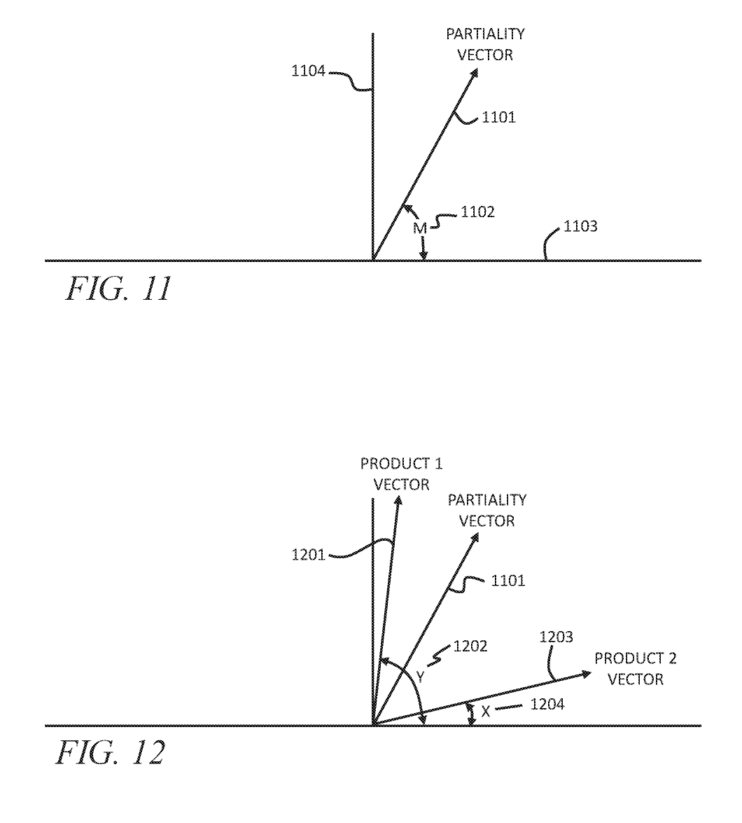

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv—P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥1/2∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥1/2∥), but the dot product for the $10/week organic apples may now drop (for example, to ∥1/2∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

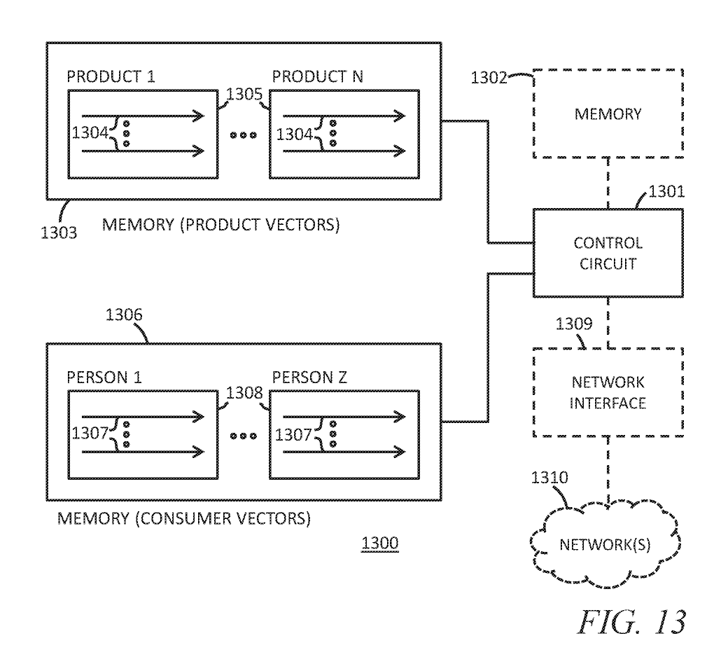

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

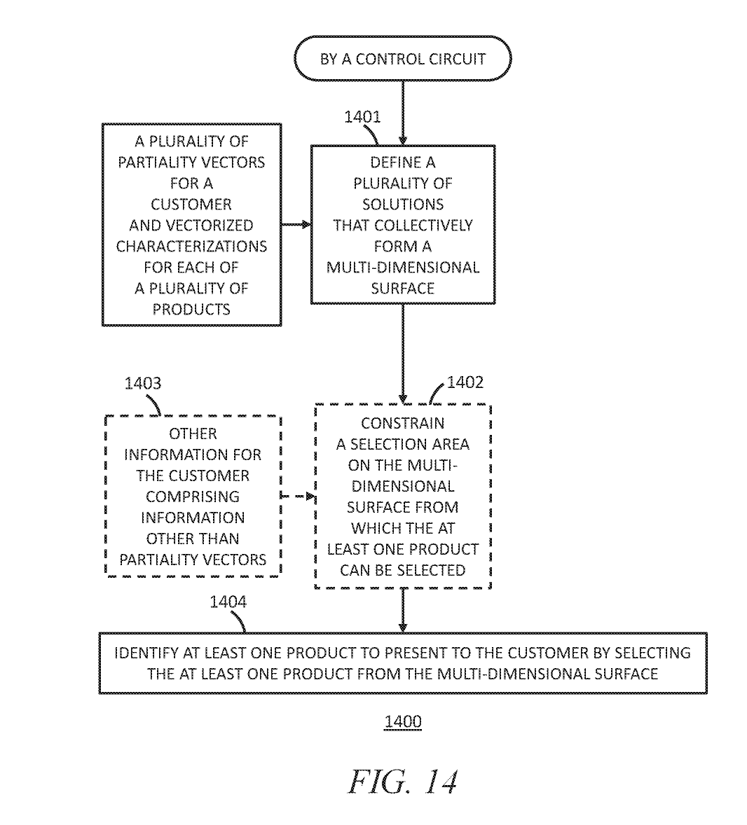

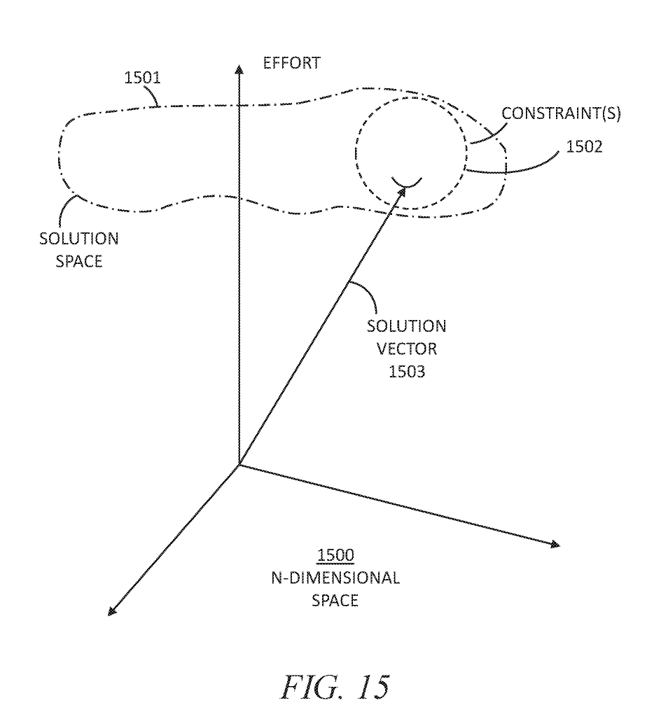

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

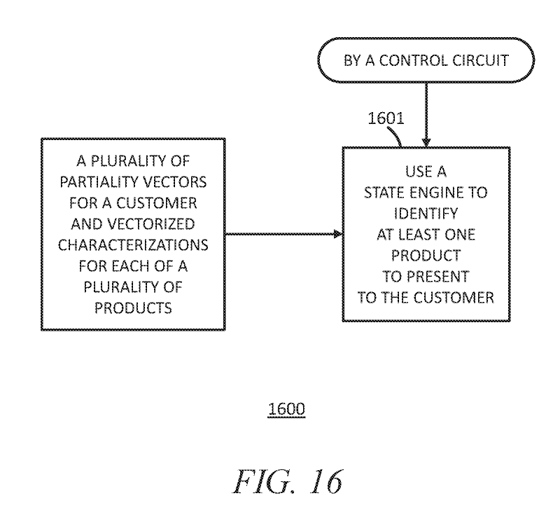

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

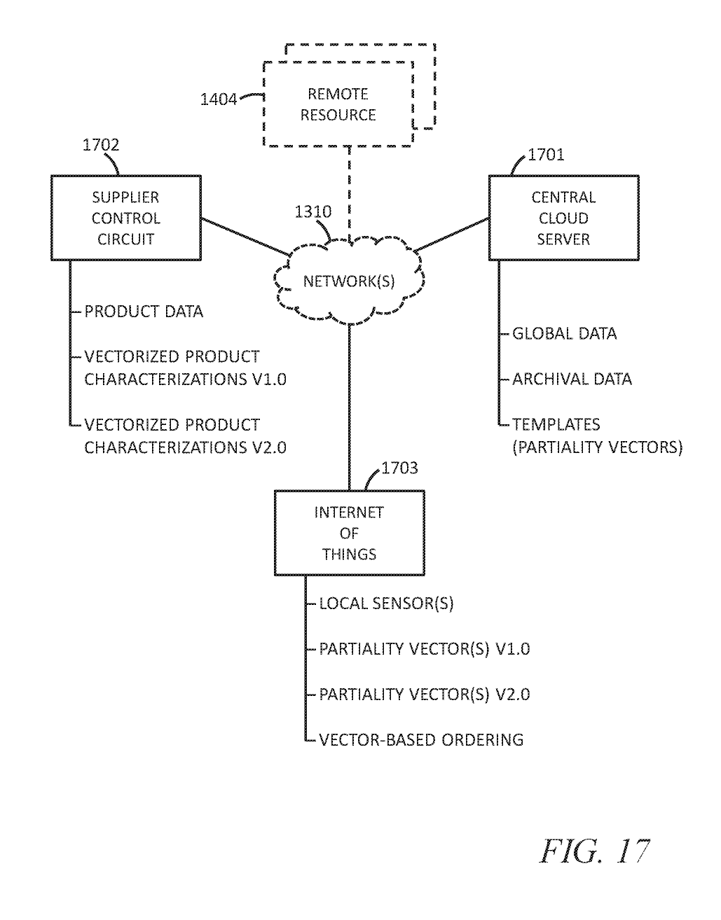

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

With subscription home delivery services, the customer may receive a delivery of one or more items selected for them by a seller. The customer may elect to accept some or none of the items delivered and may only be charged for the items they accept. Items that are not accepted by the customer may be retrieved during the next delivery and brought back to one or more of a retail, storage, distribution, or dispatch facility.

In one embodiment, a system for processing returns comprises: a customer profile database, a communication device, and a control circuit coupled to the customer profile database and the communication device. The control circuit being configured to: receive, via the communication device, information on a return item being returned by a first customer associated with a delivery agent, retrieve customer partiality vectors of a plurality of customers associated with the delivery agent from the customer profile database, select a second customer from the plurality of customers based on the partiality vectors of the second customer, and instruct the delivery agent to reroute the return item from the first customer to the second customer.

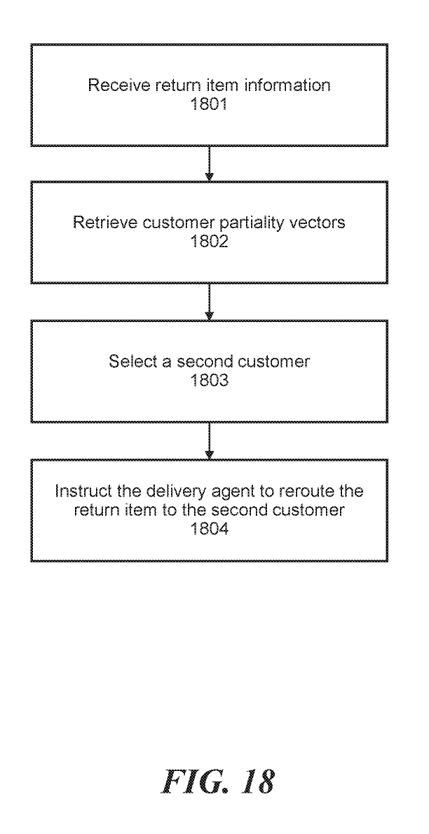

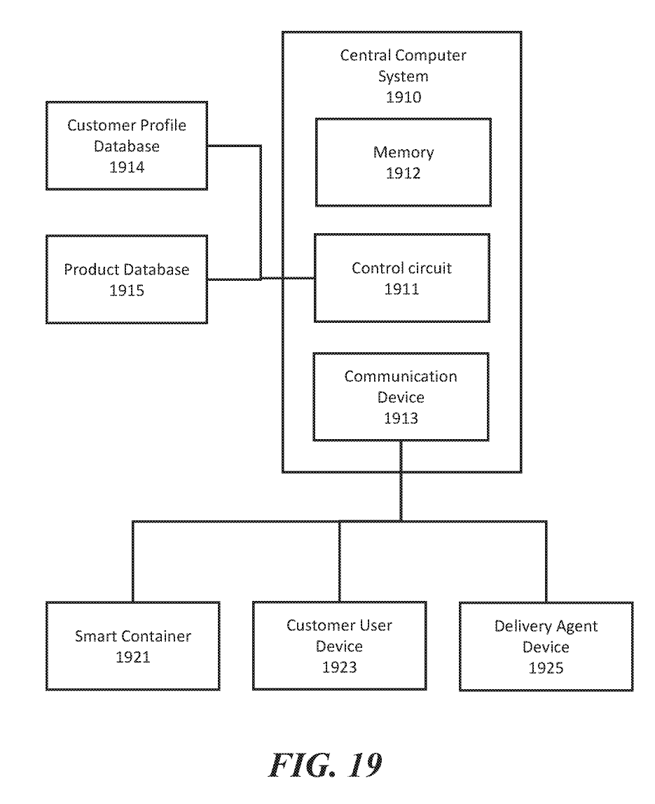

Referring next to FIG. 18, a method for processing returns according to some embodiments is shown. The steps in FIG. 18 may generally be performed by a processor-based device such as a central computer system, a server, a cloud-based server, a delivery management system, a retail management system, etc. In some embodiments, the steps in FIG. 18 may be performed by one or more of the control circuit 1301 described with reference to FIG. 13, the control circuit 1911, and the delivery agent device 1925 described with reference to FIG. 19 herein.

In step 1801, the system receives return item information. The information may comprise a listing of one or more items being returned by a first customer. In some embodiments, the return item information may be received from one or more of a smart container, a customer user device, and a delivery agent device. In some embodiments, a user may enter and/or scan items they are accepting and/or not accepting to indicate which items are being returned. In some embodiments, the return item information may be received by a portable device carried by a delivery agent. For example, a delivery agent, upon seeing items left for return at the first customer's location, may enter/scan in item information to indicate which items are being returned. In some embodiments, the return item information may be received from a smart container device configured to receive and hold items delivered to the customer prior to the items being retrieved by the customer. For example, a container configured to receive deliveries at the customer's premise may comprise one or more sensors and a communication device for communicating with a server. In some embodiments, the container may scan items that are placed and/or removed from the container. In some embodiments, the container may sense for its content periodically and/or as initiated by a server. The sensor may be configured to scan one or more of a barcode, a radio frequency identification (RFID) tag, item weight, etc. In some embodiments, items that are left in the container at a prescribed time (e.g. 24 hours after delivery, 2 hours before next delivery, etc.) may be assumed to be items being returned by the customer.

In some embodiments, the system may use return information associated with a customer update one or more of the customer's profile, partiality vectors, value vectors, preference vectors, and affinity vectors. In some embodiments, the system may prompt a customer to enter and/or select a reason for declining the delivery of an item. The entered reasons may be used to update the customer's profile and/or partiality vectors.

In step 1802, the system retrieves customer partiality vectors. In some embodiments, the customer partiality vectors may be stored in a customer profile database. In some embodiments, the customer partiality vectors each represents at least one of a person's values, preferences, affinities, and aspirations. In some embodiments, customer value vectors each comprises a magnitude that corresponds to the customer's belief in good that comes from an order associated with that value. In some embodiments, the customer partiality vectors may be determined and/or updated with a purchase history of the customer. In some embodiments, the system may retrieve customer partiality vectors of customers associated with the same delivery agent as the first customer returning the item in step 1801. In some embodiments, the system may retrieve customer partiality vectors associated with customers on the delivery route of the delivery agent. In some embodiments, the system may retrieve customer partiality vectors associated with customers who come after the first customer on a delivery route of the delivery agent. In some embodiments, the system may retrieve customer partiality vectors associated with customers within a set distance and/or travel time from the first customer's location and/or the delivery agent's route. In some embodiments, the system may retrieve customer partiality vectors associated with customers in the delivery's agent's geographic region (e.g. zip code, neighborhood, city, district, county, metropolitan area, market area, etc.).

In step 1803, the system selects a second customer from the plurality of customers based on the partiality vectors of the second customer. In some embodiments, the second customer is selected by comparing the customer partiality vectors of the second customer with customer partiality vectors associated with the first customer. For example, the system may find a second customer in the neighborhood that has similar partiality vectors as the first customer as the new recipient of the return items. In some embodiments, the second customer is selected by comparing the customer partiality vectors of the second customer with vectorized product characterizations associated with the return item(s). For example, the system may find a second customer in the neighborhood with partiality vectors that aligns the vectorized item characteristics of the return items as the new recipient of the return items. In some embodiments, the alignment between the first and second customer and/or the item and the second customer may be determined by adding, subtracting, multiplying, or dividing the magnitudes of the corresponding vectors. For example, an alignment score between a customer and a product may be determined by subtracting the magnitude of each the customer vector from the magnitude of the associated product characterization vector. In some embodiments, compatibility may be determined based on whether the scores of each vectors exceeds a set score (e.g. 0, -1, etc.). In some embodiments, scores for each vector may be determined by multiplying the vector magnitude of the second customer and the vector magnitude of the associated product characterization vector. In some embodiments, scores for each vector may be added together and/or averaged to determine an overall alignment score and compatibility may be determined based on whether the overall alignment score exceeds a set threshold. In some embodiments, a new recipient may be selected for each return item in step 1803 such that return items from a customer may be rerouted to two or more different customers.

In some embodiments, the system may balance the added travel time for rerouting the returned item from the first customer to the second customer with how well the return item and/or the partialities of the first customer aligns with the partialities of the second customer in the selection of the second customer. For example, a ten minutes of added travel time may be permitted if the customer has a high alignment with the return item, and only five minutes of added travel time may be permitted if the customer only has a moderate alignment for the return item. In another example, a customer that is a moderately aligned to an item may be selected over a customer that has a close alignment with the return if the customer is considerably closer to the delivery route of the delivery agent. In some embodiments, the system may further select the second customer based on customers' purchase history. For example, the system may determine whether the second customer could use an item for replenish or has just recently purchased a similar item. The system may then select a customer who is likely be running low on the return item as a recipient over another customer who had recently made a similar purchase.

In step 1804, the system instructs the delivery agent to reroute the return item from the first customer to the second customer. In some embodiments, the instructions may be displayed on a user interface on a delivery agent device. In some embodiments, the instructions may comprise machine instructs to a delivery vehicle and/or robot. In some embodiments, the delivery agent may be instructed to retrieve the return item from the first customer's location and delivery the item to the second customer as part the planned delivery route. In some embodiments, the system may instruct for the return item to be placed in a container headed to the second customer's location in the delivery vehicle, and the return item may be delivery along with the originally planned delivery. In some embodiments, the system may further determine a new route for the delivery agent to reroute the return item(s). In some embodiments, if the return information is received prior to the beginning of a delivery trip, the system may configure a route for the delivery trip prior to the delivery agent's departure. In some embodiments, if the return information is received during a delivery trip, the system may modify and/or add to the subsequent portion of the delivery route to reroute the return item(s). In some embodiments, the routes may be configured and/or modified based on rerouting multiple return items from and to multiple customer locations. In some embodiments, the delivery agent may be instructed to reroute the return item from the first customer to the second customer without bringing the return item back to a retail, storage, distribution, or dispatch facility. For example, the return item may go direction from the first customer to a delivery vehicle, and to the second customer's location. In some embodiments, the delivery agent may be instructed to transfer return item(s) to another delivery agent to complete the delivery.

In some embodiments, the delivery instructions may be provided to a delivery agent via a user device carried by the delivery agent. For example, when a delivery agent retrieves a return item, the delivery agent may scan the item with the user device and receive a new destination for the return item. In some embodiments, the user device may instruct the delivery agent to place the item into a partially filled or empty delivery container destined for the second customer. In some embodiments, the user device may further be configured to print out a new label and/or packing slip for the return item. In some embodiments, the user device may further be configured to provide destination addresses and/or route guidance for the delivery agent for rerouting one or more return items.

In some embodiments, the delivery agent may comprise one or more automatous, semi-automatous, and unmanned delivery robots and/or vehicles. In step 1803, the system may send item retrieval and navigation instructions to the delivery robot and/or vehicle to perform the rerouting of return items. For example, the system may cause the delivery robot and/or vehicle to travel according to a route determined based on the rerouting of one or more return items.

Referring next to FIG. 19, a block diagram of a system according to some embodiments is shown. The system comprises a central computer system 1910, a customer profile database 1914, a product database 1915, and one or more of a smart container 1921, a customer user device 1923, and delivery agent device 1925.

The central computer system 1910 may comprise processor-based system such as one or more of a server system, a computer system, a cloud-based server, a delivery management computer system, a retail management system, and the like. The control circuit 1911 may comprise a processor, a central processor unit, a microprocessor, and the like. The memory 1912 may include one or more of a volatile and/or non-volatile computer readable memory devices. In some embodiments, the memory 1912 stores computer executable codes that cause the control circuit 1911 to receive return information, select a customer as the recipient of the return item(s) based on the information in the customer profile database 1914, and instruct the rerouting of the return item to the selected customer. In some embodiments, the control circuit 1911 may be configured to determine and/or modify the delivery route for one or more delivery agents. In some embodiments, the control circuit 1911 may be configured to update the customer partiality vectors in the customer profile database 1914 based on the user's delivery acceptance and/or return histories. In some embodiments, computer executable code causes the control circuit 1911 to perform one or more steps described with reference to FIG. 18 herein.

The communication device 1913 may comprise one or more of a wired and wireless communication devices such as a network adapter, a data port, a Wi-Fi transceiver, a modem, etc. In some embodiments, the communication device 1913 may be configured to communicate with one or more of the smart container 1921, the customer user device 1923, and the delivery agent device 1925 via one or more of the Internet, a secured data connection, and a mobile data network.

The central computer system 1910 may be coupled to the customer profile database 1914 and/or the product database 1915 via a wired and/or wireless communication channel. The customer profile database 1914 may be configured store customer profiles for a plurality of customers of a home delivery service. Each customer profile may comprise one or more of customer name, customer address, customer demographic information, and customer partiality vectors. Customer partiality vectors may comprise one or more of a customer value vectors, customer preference vectors, and customer affinity vectors. In some embodiments, the customer partiality vectors may be determined and/or updated based one or more of customer purchase history, customer survey input, customer item return history, and/or customer return comments. In some embodiments, customer partialities determined from a customer's purchase history in one or more product categories and may be used to match the customer to a product in a category from which the customer has not previously made a purchase. For example, customer partialities determined from the customer's purchase of snacks and pet foods may indicate that the user values natural products. The value vector and magnitude associated with natural products may then be used to match the user to products in the beauty and personal care categories.

The product database 1915 may store one or more profiles of products offered for sale through the delivery service. In some embodiments, the products profile may associated product identifiers (e.g. Universal Product Code (UPC), barcode, product name, brand name, etc.) with vectorized product characterizations. In some embodiment, the vectorized product characterizations may comprise one or more of vectors associated with customer values, preferences, affinities, and aspirations in reference to the products. For example, a product profile may comprise of vectorized product value characterization that includes a magnitude that corresponds to how well the product aligns with a customer's cruelty-free value vector. In some embodiments, the vectorized product characterizations may be determined by one or more of product packaging description, product ingredients list, product material, product specification, brand reputation, and customer feedback.

While the customer profile database 1914 and the product database 1915 are shown outside the central computer system 1910 in FIG. 19, in some embodiments, the customer profile database 1914 and the product database 1915 may be implemented as part of the central computer system 1910 and/or the memory 1912. In some embodiments, the customer profile database 1914 and the product database 1915 comprise database structures that represent customer partialities and product characterizations, respectively, in vector form.

The smart container 1921 may comprise a delivery receiving container that includes one or more sensors and a communication device for communicating with the central computer system 1910. In some embodiments, the smart container 1921 may comprise a sensor for scanning items that are placed and/or removed from the container. In some embodiments, the smart container 1921 may sense for its content periodically and/or when instructed by the central computer system 1910. The sensor may be configured to scan one or more of a barcode, a radio frequency identification (RFID) tag, item weight, etc. associated with items. In some embodiments, items that are left in the container at a prescribed time (e.g. 24 hours after delivery, 2 hours before next delivery, etc.) may be assumed to be items being returned by the customer. In some embodiments, the smart container 1921 comprises a communication device such as a Wi-Fi transceiver, a cellular signal transceiver, a mobile data network transceiver, a Bluetooth transceiver, etc. for communicating with the central computer system 1910 via one or more of the customer user device 1923, a customer home network, a mobile data network, a secured data network, and the Internet. In some embodiments, the smart container 1921 may further comprise a locking mechanism for securing the content of the container from unauthorized access. In some embodiments, the smart container 1921 may comprise a temperature controlled storage unit.

The customer user device 1923 may comprise a processor-based device associated with a customer. In some embodiments, the customer user device 1923 may comprise one or more of a desktop computer, a laptop computer, a tablet computer, a smartphone, and the like. In some embodiments, the customer user device 1923 comprises a communication device such as a Wi-Fi transceiver, a cellular signal transceiver, a mobile data network transceiver, a Bluetooth transceiver, etc. for communicating with the central computer system 1910 via a network such as one or more of the a customer home network, a mobile data network, a secured data network, and the Internet. The customer user device 1923 may be configured to display a user interface provided by the central computer system 1910 to the customer for interacting with and configuring delivery services. In some embodiments, the customer user device 1923 may be used by a customer to enter return information. For example, in some embodiments, the user interface may be configured display an item list associated with one or more deliveries. The customer may use the customer user device 1923 to select items they wish to keep and/or return. In some embodiments, the customer may scan an identifier (e.g. barcode, RFID tag, etc.) on the item they wish to return to create return information for the central computer system 1910. In some embodiments, the user interface may further prompt the customer to provide a reason for the return. In some embodiments, a list of items to be delivered may be display to the user prior to the arrival of the delivery agent. The customer may then decline the delivery of one or more items generate return information for the central computer system 1910 prior to the arrival of the actual item and. The central computer system 1910 may process this type of return information similarly by selecting an alternate customer for the items the customer do not wish to receive.

The delivery agent device 1925 may comprise a processor-based device associated with a delivery agent. In some embodiments, the delivery agent device 1925 may comprise one or more of a tablet computer, a smart phone, a handheld scanner, an in-vehicle computer system, a vehicle or robot navigation system, a vehicle or robot controls system, a vehicle or robot control circuit, and the like. In some embodiments, the delivery agent may comprise one or more of a delivery personnel, an unmanned, automatous, and/or semi-automatous delivery robots and/or vehicles. In some embodiments, the delivery agent device 1925 comprises a communication device such as a Wi-Fi transceiver, a cellular signal transceiver, a mobile data network transceiver, a Bluetooth transceiver, etc. for communicating with the central computer system 1910 via a network such as one or more of the a customer home network, a mobile data network, a secured data network, and the Internet. The delivery agent device 1925 may be configured to provide return information indicating items being returned by a customer to the central computer system 1910. In some embodiments, the delivery agent device 1925 may comprise one or more sensor such as an optical sensor, a barcode scanner, a RFID scanner, etc. In some embodiments, when a delivery agent sees that items has been left in a delivery container by a customer to return to the delivery service, the agent may use the delivery agent device 1925 to scan the items to indicate which items are being returned. In some embodiments, a sensor may be positioned at the delivery vehicle and be configured to automatically scan items as they enter or exit the item holding portion of the vehicle. In some embodiments, the delivery agent device 1925 may be configured to display a list of items associated with a customer. For example, a list of item associated with a previous delivery to a customer may be automatically displayed based on the GPS location of the delivery agent device 1925. A delivery agent may then select which items have been accepted and/or are being returned from the display list. In some embodiments, the delivery agent device 1925 may further comprise a user interface for instructing the delivery and/or rerouting of items. In some embodiments, the delivery agent device 1925 may display a new destination for return item. In some embodiments, the delivery agent may be instructed to place the return item into a container/bin designated for the selected customer. In some embodiments, the delivery agent device 1925 and/or a separate device may print a new delivery label and/or packing list for the return item. In some embodiments, the central computer system 1910 may further provide navigation instructions to the delivery agent device 1925 for deliveries. In some embodiments, the navigation instructions may be based on a delivery routes determined and/or updated based on rerouting return items to different customers.

In some embodiments, the central computer system 1910 may receive return information from one or more of the smart container 1921, the customer user device 1923, and the delivery agent device 1925. In some embodiments, one or more of the product database 1915, the smart container 1921, and the customer user device 1923 may be optional to the system. For example, in some embodiments, an alternative recipient may be selected by comparing the partiality vectors of customers with the original recipient instead of comparing customer partiality vectors of customers with vectorized product characterizations in the product database 1915. In another example, a delivery agent may enter return information via the delivery agent device 1925 in the absence of a smart container 1921. In some embodiments, return information received from two or more of the smart container 1921, the customer user device 1923, and the delivery agent device 1925 may be compared to ensure consistency.

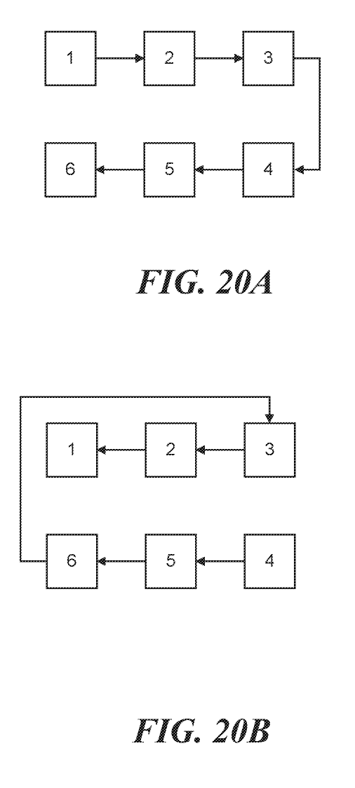

Next referring to FIGS. 20A and B, illustrations of a delivery route is shown. In FIG. 20A, an example of a delivery route of a delivery agent is shown. The delivery route includes customers 1-6. In some embodiments, when selecting a second customer to receive return items, the system may consider any customer on the same delivery route. In some embodiments, the system may only consider customers that are further down the delivery route. For example, if a return item is retrieved from customer 2, the system may select a recipient from among customers 3-6. In some embodiments, the system may instruct the delivery agent to repeat at least part of the route to reroute return items. For example, the system may instruct the delivery agent to revisit customers 1 and 2 prior to delivery one or more return items before returning to the dispatch facility.

In some embodiments, the system may be configured to determine and/or modify a route for the delivery to reroute return item(s). For example, if items returned by customer 3 is matched with customer 1 and items returned by customer 5 is matched with customer 2, the system may determine an alternate delivery route as shown in FIG. 20B such that return items are rerouted without repeating part of the delivery route.

FIGS. 20A and 20B are shown as examples only. In some embodiments, a delivery route may comprise any number of customers and/or stops. In some embodiments, one or more customers may be skipped if no deliveries are scheduled for that trip. In some embodiments, the route may be modified during a delivery trip. For example, after retrieving a return item from customer 3, the system may instruct the delivery agent to return to customer 2 to reroute the return item to customer 2 before proceeding to customer 4. In some embodiments, a delivery agent may be instructed to reroute return items to a customer outside of the normal delivery route and/or coverage area. In some embodiments, a delivery agent may be instructed to transfer the return items to another delivery agent to complete the delivery.

In one embodiment, a system for processing returns comprises: a customer profile database, a communication device, and a control circuit coupled to the customer profile database and the communication device. The control circuit being configured to: receive, via the communication device, information on a return item being returned by a first customer associated with a delivery agent, retrieve customer partiality vectors of a plurality of customers associated with the delivery agent from the customer profile database, select a second customer from the plurality of customers based on the partiality vectors of the second customer, and instruct the delivery agent to reroute the return item from the first customer to the second customer.

In one embodiment, a method for processing returns comprises receiving, via a communication device coupled to a control circuit, information on a return item being returned by a first customer associated with a delivery agent, retrieving customer partiality vectors of a plurality of customers associated with the delivery agent from a customer profile database, selecting, with the control circuit, a second customer from the plurality of customers based on the customer partiality vectors of the second customer, and instructing, with the control circuit, the delivery agent to reroute the return item from the first customer to the second customer.

In one embodiments, an apparatus for processing returns comprises a non-transitory storage medium storing a set of computer readable instructions and a control circuit configured to execute the set of computer readable instructions which causes to the control circuit to: receive, via a communication device coupled to the control circuit, information on a return item being returned by a first customer associated with a delivery agent, retrieve customer partiality vectors of a plurality of customers associated with the delivery agent from a customer profile database, select a second customer from the plurality of customers based on the customer partiality vectors of the second customer; and instruct the delivery agent to reroute the return item from the first customer to the second customer.

Crowd Sourced Item Return

In some embodiments, systems, apparatuses and methods are provided herein useful to utilize third parties for the return and/or exchange of items. A consumer wanting to return an item can inform an entity and then the entity can source the item retrieval and delivery to one or more delivery agents. In some embodiments, the consumer can also indicate an item wanted in exchange for the item to be returned. Similarly, the entity can then source the retrieval and delivery of both the returned item and the exchanged item to one or more delivery agents. Moreover, rather than return the item back to a store location, the entity can instead direct the delivery agent to deliver the item to a second customer.

Generally speaking, pursuant to various embodiments, systems, apparatuses and methods are provided herein useful to utilize third parties for the return and/or exchange of items. More specifically, a consumer wanting to return an item can inform an entity of the desire to return the item. The entity can then source the item pick-up and return to one or more delivery agents. This advantageously allows a consumer to easily return an unwanted item without having to travel. If desired, the consumer can also indicate an item wanted in exchange for the item to be returned. Similarly, the entity can then source the pick-up and drop-off of both the returned item and the exchanged item to one or more delivery agents. Moreover, rather than return the item back to a store location from which the item was purchased, the entity can instead direct the delivery agent to deliver the item to a second customer. These various embodiments, systems, apparatuses, and methods advantageously utilize third party agents that agree to undertake the return and/or exchange rather than a traditional shipping company, which can lower transportation and return costs for the customer and/or the store.

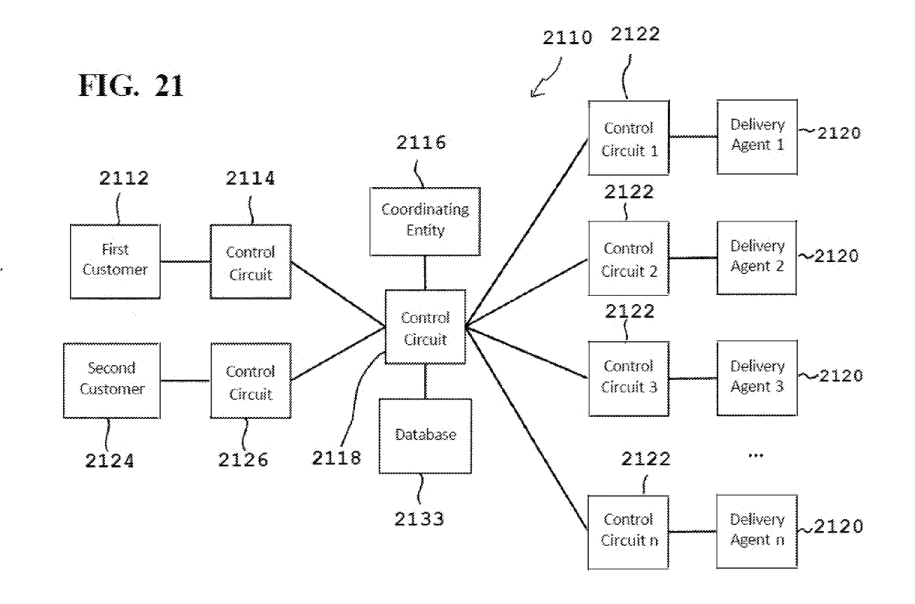

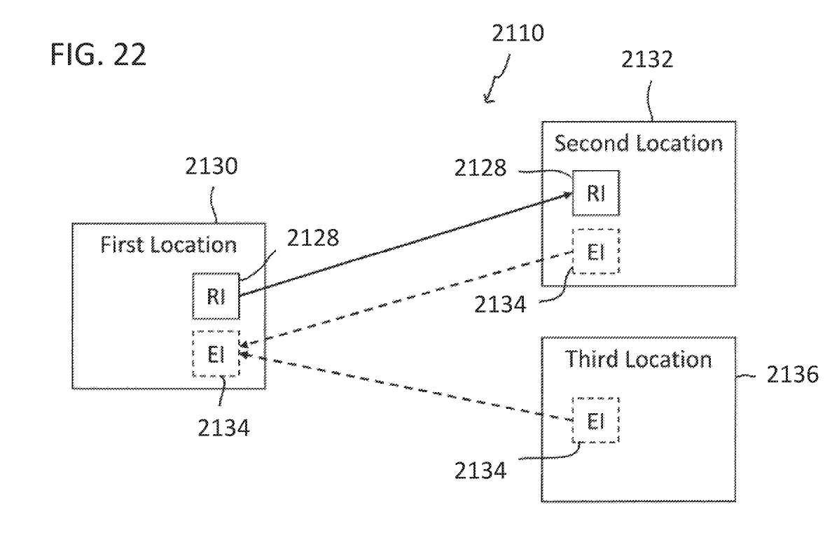

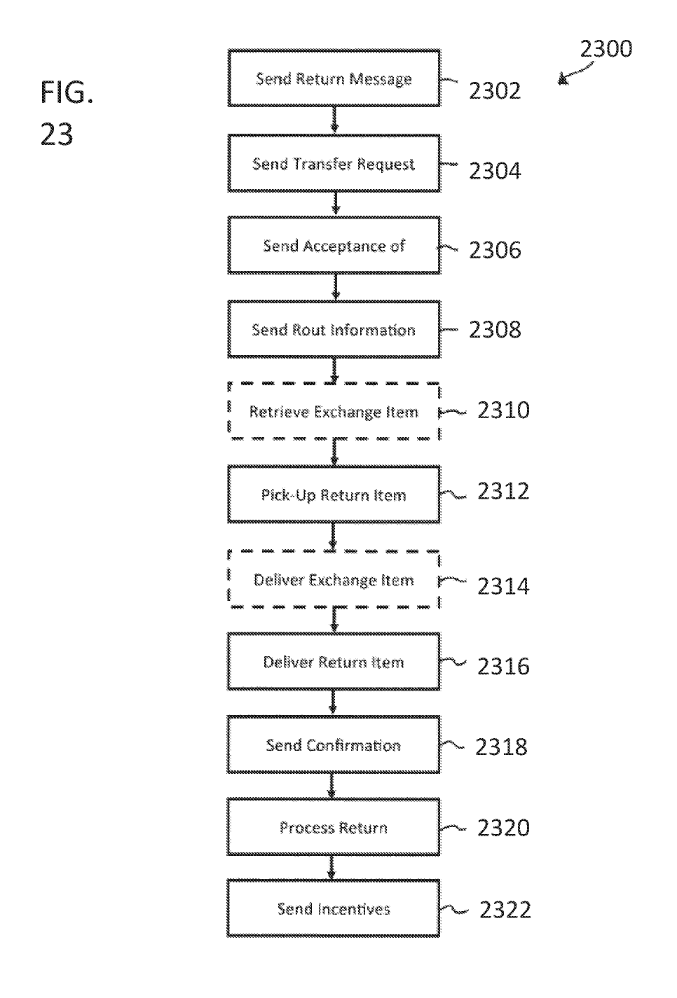

Details of an item return system 2110 are described below with reference to FIGS. 21-23. The system 2110, shown in FIGS. 21 and 22, includes interactions between a first customer 2112 operating a first customer control circuit 2114, a coordinating entity 2116 operating a coordinating entity control circuit 2118, and one or more delivery agents 2120₁₋ₙ operating delivery agent control circuits 2122₁₋ₙ. Optionally, the system 2110 can include interactions with a second customer 2124 operating a second customer control circuit 2126.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuits 2114, 2118, 2122 described herein may be configured (for example, by using corresponding programming stored in a memory as will be well understood by those skilled in the art) to carry out one or more of the steps, actions, and/or functions described herein.

The system 2110 can advantageously be used to return and exchange items as described in more detail below. The communications between the control circuits 2114, 2118, 2122 can take any suitable form, including short message service (SMS), email, voice, VOIP, chat message, or the like, over any suitable network, including radio communication, Internet, near field communication, Bluetooth, or the like. The communications can be initiated by a user input to the respective control circuits 2114, 2118, 2122 or by automated responses. The control circuits 2114, 2118, 2122 can generate graphical user interfaces (GUIs) presenting the options, inputs, and entry fields described herein. In a thin client example, such as a browser on a computer, the control circuits 2114, 2118, 2122 generate the GUI by preparing a full GUI for transmission. In a thick client example, such as a dedicated application executing on a mobile device, the control circuits 2114, 2118, 2122 generate the GUI by preparing values for transmission to be presented within the GUI.

As shown in the flowchart depicted in FIG. 23, the first customer 2112 can begin a transaction 2300 to return a return item 2128 by sending 2302 a return message to the control circuit 2118 of the coordinating entity 2116. The return message can provide return information, such as an identification of the return item 2128, purchaser identification, a purchase date, a purchase location, reasons for return, a first location 2130 of the return item, etc., entered into the first customer control circuit 2114 or retrieved thereby. The coordinating entity 2116 can be the store to whom the item 2124 was purchased and is being returned or a third party.

By one approach, the first customer 2112 can request that the return item 2128 be exchanged for an exchange item 2134. As such, the first customer control circuit 2114 can send 2302 the return message to the coordinating entity control circuit 2118 with exchange information. The exchange information can include an identification of the exchange item 2134, which can be entered into the first customer control circuit 2114 or retrieved thereby.

In response to reception of the return message, the coordinating entity control circuit 2118 can then send 2304 a transport request message to one or more of the delivery agents 2120 providing transportation information, such as an identification of the return item 2128, the first location 2130 for pick-up of the return item 2128, a second location 2132 for delivery of the return item 2128. In the exchange scenario, the transportation information can further include a location of the exchange item 2134, whether the location be at the second location 2132 or a third location 2136.

By one approach, the transport request message can further identify incentives for the delivery agent 2120 for completion of the transaction. By one approach, the incentives can be non-monetary, such as one or more of a credit to the store, a coupon, a sale code, or the like. By another approach, the incentives can be monetary.

The coordinating entity control circuit 2118 can be operably coupled to a database device 2133 to retrieve or receive data therefrom. More specifically, the database device 2133 can have data stored thereon pertaining to the transaction, including sales transaction data for the return item 2128, including identification of the return item 2128, purchaser identification, a purchase date, a purchase location, and the like, delivery agent data, including identification of the delivery agents, contact information, hours of operation, and the like, customer data, including customer locations, identities, contact information, and the like, and value information for one or more of the customers, including partiality data, described in more detail below.

One of the delivery agents 2120 can then choose to accept the transport request by sending 2306 an accept message to the coordinating entity control circuit 2118. The accept message can include identification information, including one or more of a name of the delivery agent, a photo of the delivery agent, identification information for the vehicle of the delivery agent, information regarding past transactions of the delivery agent, and the like, entered into the control circuit 2122 or retrieved thereby. If desired, the coordinating entity 2116 can forward some or all of the delivery agent identification information to the first customer control circuit 2114.

In response to reception of the accept message, the coordinating entity control circuit 2118 can then send 2308 route information to the delivery agent control circuit 2122. The route information can include the first location 2130, one or more driving routes to the first location 2130, the second location 2132, one or more available driving routes extending between the first location 2130 and the second location 2132, and, if applicable, the third location 2136, and one or more available driving routes extending between the third location 2136 and the first location 2130. Therefore, in an exchange situation, the delivery agent 2120 can then go to either the second or third location 2132, 2136 to retrieve 2310 the exchange item 2134. The delivery agent 2120 can then proceed to the first location 2130 to retrieve 2312 the return item 2128 and, if applicable, deliver 2314 the exchange item 2134. Finally, the delivery agent 2120 can then proceed to the second location 2132 to deliver 2316 the return item 2128.

By one approach, the second location 2132 can be a location for the store. As such, whether a return or exchange action, the delivery agent 2120 can travel between the first and second locations 2130, 2132 to complete the transaction. By another approach, the second location 2132 can be a location of the second customer 2124 and the third location 2136 can be a location for the store. More specifically, the second customer 2124 can make a separate purchase request for the item 2128 either with the coordinating entity control circuit 2118 or a system associated therewith. The coordinating entity 2116 can then determine that the location 2132 of the second customer 2124 is within a predetermined distance of the first location 2130. In response to a positive determination, the coordinating entity 2116 can instruct the delivery agent 2120 to deliver 2316 the item 2128 to the second customer 2124 at the second location 2132 rather than a location of the store. In this case, the coordinating entity 2116 can further instruct the delivery agent 2120 to retrieve 2310 the exchange item 2134 from the third location 2136 and deliver 2314 the exchange item 2134 to the first location 2130.

With any of the above scenarios, after the delivery agent 2120 has completed the transaction, the delivery agent control circuit 2122 can send 2318 a confirmation message to the coordinating entity control circuit 2118. The coordinating entity control circuit 2118 can then create or forward 2318 the confirmation message to the first customer control circuit 2114 as a receipt message. Additionally, or alternatively, the coordinating entity control circuit 2118 can process 2320 the return for the return item 2128.

Further, in response to the confirmation message, the coordinating entity 2116 can send 2322, or release or identify a location of, the incentives for completing the transaction to the delivery agent control circuit 2122.

If desired, the system 2110 can be expanded to allow the delivery agent 2120 to pick up multiple return items 2128 along a designated route. This efficiently utilizes the time and location of the delivery agent 2120 to reduce costs. So configured, the delivery agent 2120 can accept 2306 multiple transfer requests 2304 and the coordinating entity control circuit 2118 can send 2308 route information regarding the location 2130 of each of return items 2128.

Turning back to the system 2110 described above with respect to FIGS. 21-23, the coordinating entity 2116 can utilize the approaches set forth above with respect to FIGS. 1-17 to determine whether the second customer 2124 has value information indicating one or more partialities for the return item 2128. Rather than instructing the delivery agent 2120 to deliver the return item 2128 to a location of the store or to a location of a customer that purchased the item, the coordinating entity 2116 can instruct the delivery agent 2120 to deliver the return item 2128 to a location of the second customer 2124 in response to determining that the second customer has one or more partialities for the return item 2128. Further, the coordinating entity 2116 can provide this instruction without having a prior purchase transaction for the return item 2128 from the second customer 2124 due to the expected valuation. If the coordinating entity 2116 does not find a customer within a predetermined area around the first location 2130 with partialities for the return item 2128, the coordinating entity 16 can instruct the delivery agent 2120 to keep the return item 2128 as payment or incentive for the retrieval thereof.

Systems and Methods for Handling Return Request

In some embodiments, systems, apparatuses, and methods are provided herein for handling return requests. A system for handling return requests comprises a communication device configured to communicate with a plurality of user devices, a customer database storing customer profiles associated with a plurality of customers, a product database storing characteristics associated with a plurality of products, an order database, and a control circuit. The control circuit being configured to receive a request to return an item from a user device associated with a first customer, verify that the request to return the item complies with return restrictions, retrieve customer profiles of a plurality of potential buyers, determine alignments between the customer profiles of the plurality of potential buyers and product characteristics of the item, select a second customer from the plurality of potential buyers based on the alignments, facilitate a transfer of the item from the first customer to the second customer.

Generally speaking, pursuant to various embodiments, systems, apparatuses and methods are provided herein for handling return requests. In some embodiments, a system for handling return requests comprises a communication device configured to communicate with a plurality of user devices, a customer database storing customer profiles associated with a plurality of customers, a product database storing characteristics associated with a plurality of products, an order database, and a control circuit coupled to the communication device, the customer database, and the product database. The control circuit being configured to receive a request to return an item from a user device associated with a first customer, verify that the request to return the item complies with return restrictions based on information stored in the order database, retrieve customer profiles of a plurality of potential buyers from the customer database, determine alignments between the customer profiles of the plurality of potential buyers and product characteristics of the item stored in the product database, select a second customer from the plurality of potential buyers based on the alignments, facilitate a transfer of the item from the first customer to the second customer, receive a transaction confirmation for the transfer of the item, and provide a program incentive to the first customer in response to receiving the transaction confirmation.

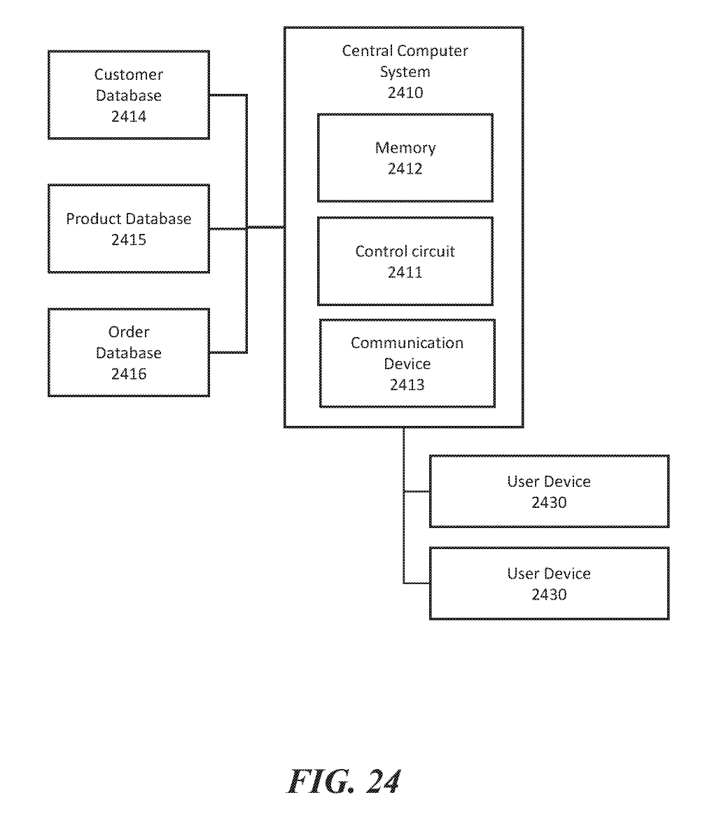

Referring next to FIG. 24, a block diagram of a system according to some embodiments is shown. The system comprises a central computer system 2410, a customer database 2414, a product database 2415, an order database 2416, and a plurality of user devices 2430.

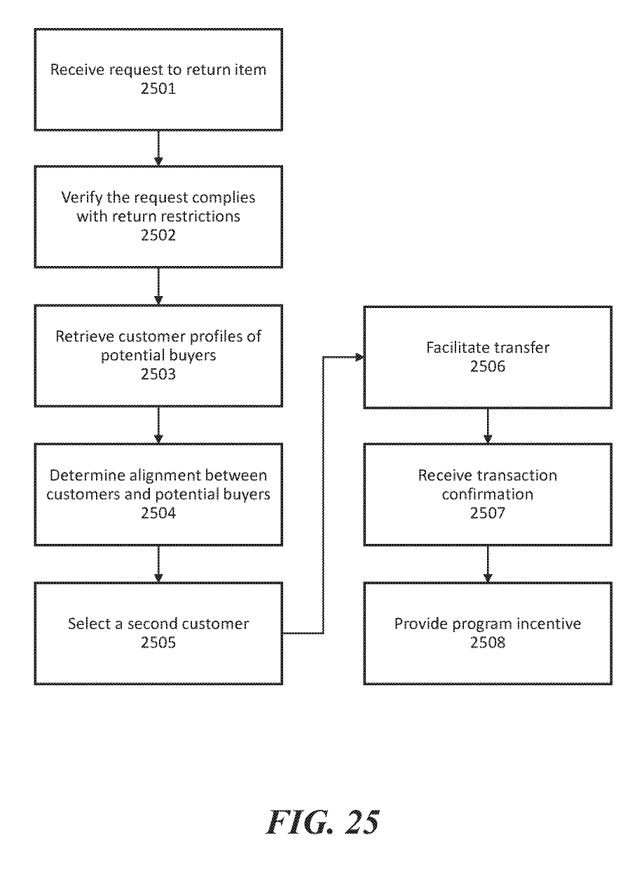

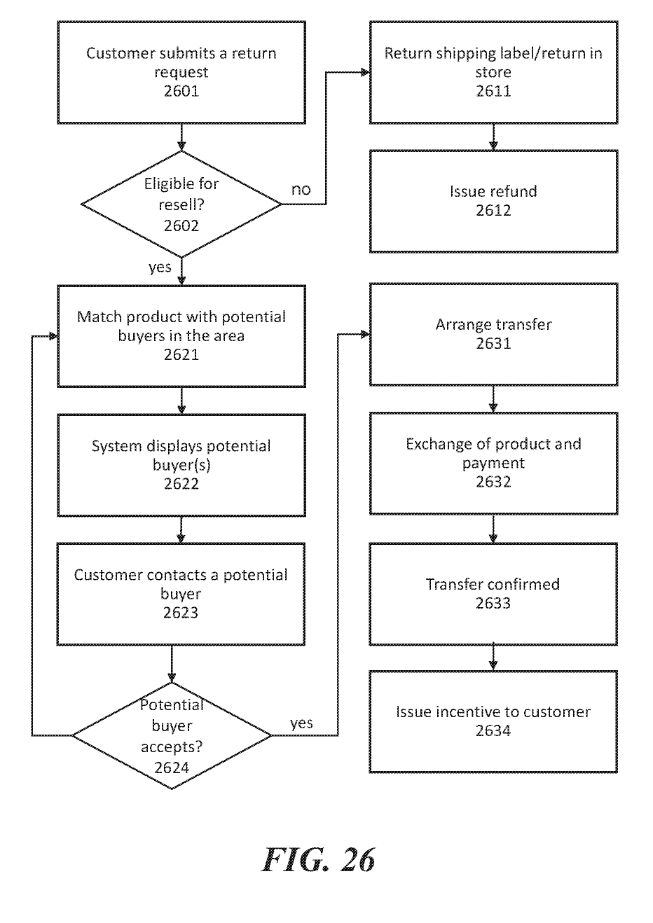

The central computer system 2410 may comprise a processor-based system such as one or more of a server system, a computer system, a cloud-based server, and the like. The central computer system 2410 comprises a control circuit 2411, a memory 2412, and a communication device 2413. The control circuit 2411 may comprise a processor, a central processor unit, a microprocessor, and the like. The memory 2412 may include one or more of a volatile and/or non-volatile computer readable memory devices. In some embodiments, the memory 2412 stores computer executable codes that cause the control circuit 2411 to provide a network-accessible user interfaces to the plurality of user devices 2430 and facilitate the reselling of items the customer wishes to return based on information stored in the customer database 2414, the product database 2415, and the order database 2416. In some embodiments, the control circuit 2411 may further be configured to update the customer profiles and/or vectors in the customer database 2414 based on items purchased and/or returned by customers. In some embodiments, the computer executable code stored on the memory 2412 may cause the control circuit 2411 to perform one or more steps described with reference to FIGS. 25 and 26 herein.

The communication device 2413 may be configured to allow the central computer system 2410 to communicate with a plurality of user devices 2430 over a network. In some embodiments, the communication device 2413 may comprise one or more of a network adapter, a data port, a network port, a modem, a router and the like. In some embodiments, the network may comprise one or more of the Internet, a public network, a private network, a secure network, a wireless data network, and the like. In some embodiments, the communication device 2413 may generally comprise one or more devices configured to allow the control circuit 2411 to exchange data with user devices 2430. In some embodiments, the communication device 2413 may further allow the central computer system 2410 to access one or more of the customer database 2414, the product database 2415, and the order database 2416.

The user devices 2430 may comprise electronic user interface devices configured to present customer user interfaces to customers. In some embodiments, a user device 2430 may comprise a control circuit, a memory, and one or more user input/output devices such as a display screen, a touch screen, a microphone, a keyboard, and the like. In some embodiments, a user device 2430 may comprise one or more of a personal computer, a laptop computer, a tablet computer, a mobile device, a smartphone, a wearable device, and the like. In some embodiments, the customer user interface may comprise one or more of a mobile application, a desktop application, a web page, a web-based user interface, etc. In some embodiments, the customer user interface may comprise a graphical user interface (GUI) that allows the user to submit a return request and utilize different return options. For example, the customer may be presented with the option to resell the item to another customer and the customer user interface may present product information and relay communications to facilitate the resell transaction between the customers.

The central computer system 2410 may be coupled to a customer database 2414, a product database 2415, and/or an order database 2416 via one or more wired and/or wireless communication channels. The customer database 2414 may be configured to store customer profiles for a plurality of customers. Each customer profile may comprise one or more of customer name, customer location(s), customer demographic information, customer configured preferences, customer purchase history, and customer vectors. Customer vectors may comprise one or more of a customer value vectors, customer partiality vectors, customer preference vectors, customer affinity vectors, and customer aspiration vectors. In some embodiments, customer value vectors each comprises a magnitude that corresponds to the customer's belief in the good that comes from an order associated with that value. In some embodiments, customer vectors may each represent at least one of a person's values, preferences, affinities, and aspirations. In some embodiments, the customer value vectors each represents at least one of a person's values leading to at least one of a plurality of possible preferences and affinities and comprises a magnitude that corresponds to the customer's belief in good that comes from an order associated with that value. In some embodiments, the customer vectors may be determined and/or updated based on one or more of customer purchase history, customer survey input, customer reviews, customer item return history, customer return comments, and customer ratings, etc. In some embodiments, customer vectors determined from a customer's purchase history and comments associated with one or more product categories may be used to match the customer to a product in a category from which the customer has not previously made a purchase. For example, customer vectors determined from the customer's purchase of snacks and pet foods may indicate that the user values natural products. The customer vector and magnitude associated with natural products may then be used to match the user to products in the beauty and personal care categories.

The product database 2415 may store one or more profiles of products offered for sale. In some embodiments, the product profile may comprise product category, product characteristics, product return restrictions, etc. In some embodiments, the product profiles may associate vectorized product characterizations with products for sale. In some embodiments, the vectorized product characterizations may comprise one or more of vectors associated with customer values, preferences, affinities, and/or aspirations in reference to the products. For example, a product profile may comprise vectorized product value characterization that includes a magnitude that corresponds to how well the product aligns with a customer's cruelty-free value vector. In some embodiments, the vectorized product characterizations may be determined based on one or more of product packaging description, product ingredients list, product specification, brand reputation, and customer feedback. In some embodiments, the product database 2415 may store other information about the product, such as product price, product storage location, product availability, product origin location, product ingredients, etc. In some embodiments, for products with unique identifiers (e.g. RFID tag, serial number, etc.), the product database 2415 and/or the order database 2416 may store item-specific information such as date of purchase, expiration date, etc.

The order database 2416 may store information on product orders associated with a plurality of customers. In some embodiments, the orders in the order database 2416 may comprise one or more of online orders, in-store purchases, home delivery orders, subscription orders, automatic delivery service orders, etc. In some embodiments, order database 2416 may store order information such as one or more of customer identity, customer address, delivery address, purchase date, purchase location, purchased product(s), product category, product expiration date, product price, unique product identifier(s), discounts, method of payment, etc. In some embodiments, the order information may comprise return restrictions on one or more products. For example, one or more return periods may be associated items in an order (e.g. 30 days, 60 days return). In another example, a product purchased on clearance may not be returned.

While the customer database 2414, the product database 2415, and the order database 2416 are shown to be outside the central computer system 2410 in FIG. 24, in some embodiments, the customer database 2414, the product database 2415, and/or the order database 2416 may be implemented as part of the central computer system 2410 and/or the memory 2412 local to the central computer system 2410. In some embodiments, the customer database 2414, the product database 2415, and/or the order database 2416 may comprise one or more server-based and/or cloud-based storage databases accessible by the central computer system 2410 and/or the user device 2430 through network connections. In some embodiments, the customer database 2414 and the product database 2415 comprise database structures that represent customer values and product characteristics, respectively, in vector form.

Referring next to FIG. 25, a method for handling return requests according to some embodiments is shown. The steps in FIG. 25 may generally be performed by a processor-based device such as a central computer system, a server, a cloud-based server, an order management system, a personal computer, a user device, etc. In some embodiments, the steps in FIG. 25 may be performed by one or more of the central computer system 2410 and/or the user device 2430 described with reference to FIG. 24 herein, and/or other similar devices.

In step 2501, the system receives a request to return an item. In some embodiments, the return request may be received from a user device associated with a first customer. In some embodiments, the system may provide a customer user interface to the customer. In some embodiments, the customer user interface may be configured to display an order history to the customer. The customer may then select one or more items in the displayed orders to indicate their intent to return the item(s). In some embodiments, the customer user interface may allow the customer to scan a barcode, scan a shipping slip, scan a Radio Frequency Identify (RFID) tag, capture an image, enter a description, etc. to identify the item(s) they wish to return. For example, the customer user interface may comprise a mobile application, and the application may use the camera of a smartphone to scan a barcode on the item that the customer wishes to return. Generally, the request to return an item may identify a customer and at least one item the customer wishes to return. In some embodiments, the system may further prompt the customer to enter other information such as the product's expiration date and whether the product has been opened, used, damaged, etc. when submitting a return request. In some embodiments, the return request may be transmitted from the user device to a retailer computer system via a network such as the Internet.

In some embodiments, a user device may comprise a user interface device configured to provide a customer user interface to a customer. In some embodiments, the user device comprises a control circuit, a memory, and one or more user input/output devices such as a display screen, a touch screen, a microphone, a keyboard, and the like. In some embodiments, the user device may comprise one or more of a personal computer, a laptop computer, a tablet computer, a mobile device, a smartphone, a wearable device, and the like. In some embodiments, the customer user interface may comprise one or more of a mobile application, a desktop application, a web page, a web-based user interface, etc. In some embodiments, the customer user interface may comprise a graphical user interface (GUI) that allows the user to submit a return request and/or participate in the resell program.

In step 2502, the system verifies that the request to return the item complies with return restrictions. In some embodiments, the return restrictions may indicate whether the item is eligible for return and/or the resell program. In some embodiments, the return restrictions may indicate whether the item can be returned through one or more of return methods such the resell program, in-store return, and return shipping. In some embodiments, the return restrictions may be determined based on information associated with the particular item (e.g. expiration date, used), the item's category (e.g. perishable, electronics), and/or the purchase order associated with the item (e.g. purchase date, payment method, etc.). In some embodiments, an item may only be eligible for the resell program, in-store return, and/or return shipping if the item matches an item previously purchased by the customer. In some embodiments, return restrictions may be associated with product categories (e.g. perishable food, refrigerated items, electronics, medicine, etc.). For example, perishable food items may only be eligible for in-store returns, and may be not returned via return shipping or resold through the resell program. In some embodiments, the system may match the item with an order in an order database to determine whether an item may be returned. For example, the system may determine whether the permitted return period has lapsed based on the purchase date associated with the item. In another example, the system may determine whether the item is purchased on clearance, with a discount, with store credit, etc. In some embodiments, return restrictions may further be determined based on customer entered information such as the product's expiration date, whether the product has been used, whether the packaging has been opened, etc. In some embodiments, return restrictions may further be determined based on customer information such as customer's recent return history, customer purchase history, customer location, etc. In some embodiments, the system may further determined whether an item is eligible for the resell program based one or more of a predicted demand for the item in the customer's geographic area and the seasonality of the item.

In some embodiments, after step 2502, the system may present the available return options to the customer via the customer user interface. For example, the user interface may provide instructions to return the item in-store, instructions to print a return mailing label, and/or a link to the resell program user interface. If the customer elects to participate in the resell program, the process may proceed to step 2503. In some embodiments, the system may perform steps 2503-2505 automatically when a return request is received, for any item that is determined to be eligible for the resell program. In some embodiments, the system may perform steps 2503 and 2504 to estimate a demand for the product in the customer's geographic area to determine whether the product is eligible for the resell program.

In step 2503, the system retrieves customer profiles associated with of a plurality of potential buyers from a customer database. In some embodiments, each customer profile may comprise one or more of customer name, customer location(s), customer demographic information, customer configured preferences, customer purchase history, and customer vectors. Customer vectors may comprise one or more of a customer value vectors, customer partiality vectors, customer preference vectors, customer affinity vectors, and customer aspiration vectors. In some embodiments, customer value vectors each comprises a magnitude that corresponds to the customer's belief in the good that comes from an order associated with that value. In some embodiments, customer vectors may each represent at least one of a person's values, preferences, affinities, and aspirations. In some embodiments, the customer value vectors each represents at least one of a person's values leading to at least one of a plurality of possible preferences and affinities and comprises a magnitude that corresponds to the customer's belief in good that comes from an order associated with that value. In some embodiments, the customer vectors may be determined and/or updated based on one or more of customer purchase history, customer survey input, customer reviews, customer item return history, customer return comments, and customer ratings, etc. In some embodiments, customer vectors determined from a customer's purchase history and comments associated with one or more product categories may be used to match the customer to a product in a category from which the customer has not previously made a purchase. For example, customer vectors determined from the customer's purchase of snacks and pet foods may indicate that the user values natural products. The customer vector and magnitude associated with natural products may then be used to match the user to products in the beauty and personal care categories.

In some embodiments, the potential buyers may comprise customers who have signed up to make purchases through the resell program. In some embodiments, the plurality of potential buyers may be selected from all profiles in the database based on locations associated with the first customer and each of the plurality of customers. For example, the system may first determine a geographical area associated with the customer (e.g. neighborhood, city, zip code, radius/travel distance from home/work address, etc.) and select customers in the geographic area as potential buyers.

In step 2504, the system determines an alignment between the customer profiles of the plurality of potential buyers and product characteristics of the item being returned. In some embodiments, product characteristics of the item being returned may be retrieved from a product database storing one or more profiles of products offered for sale. In some embodiments, the product profile may comprise product category, product characteristics, product return restrictions, etc. In some embodiments, the product profiles may associate vectorized product characterizations with products for sale. In some embodiments, the vectorized product characterizations may comprise one or more of vectors associated with customer values, preferences, affinities, and/or aspirations in reference to the products. For example, a product profile may comprise vectorized product value characterization that includes a magnitude that corresponds to how well the product aligns with a customer's cruelty-free value vector. In some embodiments, the vectorized product characterizations may be determined based on one or more of product packaging description, product ingredients list, product specification, brand reputation, and customer feedback. In some embodiments, the product database may store other information about the product, such as product price, product storage location, product availability, product origin location, product ingredients, etc.

In some embodiments, the alignments between a product and potential buyers may be determined based a comparing the potential buyer's demographic information, configured preferences, purchase history, and/or customer vectors with product characteristics in the product database. In some embodiments, the alignments between a product and potential buyers may be determined by adding, subtracting, multiplying, and/or dividing the magnitudes of the corresponding vectors in the customer vectors and product characterization vectors. In some embodiments, alignment scores for each vector may be added and/or averaged to determine an overall alignment score of between a potential buyer and the product. In some embodiments, the system may only consider the prominent vectors (e.g. high magnitude vectors) associated with the customer or the product in determining the alignment. Generally, the alignment may predict the likelihood of a potential buyer purchasing the item based on their customer profile.

In step 2505, the system selects a second customer from the plurality of potential buyers based on the alignments determined in step 2504. In some embodiments, the system may select the potential buyer with the highest alignment with the product as the second customer. In some embodiments, the system may recommend a number of potential buyers to the first customer for selection based on the alignments. In some embodiments, the system may recommend a set number of matching potential buyers with the highest matching scores or recommend all potential buyers meeting at least a matching score threshold. In some embodiments, the second customer may further be selected based on one or more of recent purchases, estimated inventories, and budget constraints of each of the plurality of potential buyers. In some embodiments, the second customer may be selected based on a combination of one or more factors. For example, the system may determine a score based on whole well the product aligns with a potential buyer, another score based on the potential buyer's distance from the first customer, and yet another score based on the potential buyer's recent purchases or estimated purchasing power. The second customer may be selected based on a combination of these scores. For example, a potential buyer who lives 1 mile away may be selected over another potential buyer with a higher alignment score. who lives 10 miles

In step 2506, the system facilitates the transfer of the item from the first customer to the second customer. In some embodiments, the “first customer” may refer to the original customer who purchased the item from the retailer and the “second customer” may refer to the secondary customer who buys the item through the original customer. In some embodiments, the “first customer” may refer to the seller in the resell transaction and the “second customer” may refer to the buyer resell transaction. In some embodiments, the system may be configured to relay messages between the first customer and the second customer to facilitate the transfer. For example, the first customer may select the second customer in the customer user interface to initiate an online chat session with the second customer via the user interface. In some embodiments, the system may provide preconfigured messages for the first customer to send to the second customer. In some embodiments, the preconfigured message may comprise a description of the item being offered, a link to a product web page, and/or the offer price of the item. In some embodiments, the system may be configured to generate an item offer message for the first customer to send to the second customer that is configured to emphasize selected characteristics of the item based on the customer profile associated with the second customer. For example, if the second customer has a value vector (e.g. environmental friendliness) with a particularly high magnitude, the system may automatically generate a message that highlights the relevant product characteristic (e.g. made from recycled material). In some embodiments, the item is offered to the second customer at a discounted price determined by the control circuit and/or the first customer. In some embodiments, the system may set the price or a price range for reselling the item that the first customer wishes to return. In some embodiments, the offer price may be determined based on the product type, the product condition, the product sales price, the product purchase price, etc. In some embodiments, the offer price may be reduced as compared to the item's price offered through the retailer.

In some embodiments, the system may be configured to recommend a transfer method, a meetup location, and/or a delivery agent based on customer profiles associated with the first customer and/or the second customer to facilitate the transfer. For example, the system may use the locations of the first and second customers to select a convenient location for the transfer without disclosing the home or work locations of the customers to each other. In another example, the system may store characteristics associated with locations (e.g. stores, parks, coffee shops) and select a location that has a high vector alignment with one or both customers. In some embodiments, the system may select/recommend a delivery agent (e.g. crowd-sourced courier, shared ride driver, etc.) to facilitate the transfer. In some embodiments, the delivery agent may further be selected/recommended based on alignments between the delivery agent's profile and the profiles of one or both of the customers.

In some embodiments, the system may be configured to facilitate a payment from the second customer to the first customer. The payment may comprise one or more of an in-person payment, a peer-to-peer electronic payment transfer, a digital currency transfer, and a store credit transfer. In some embodiments, the system may charge the second customer for the item and issue a refund to the first customer in response to receiving a transaction confirmation.

In step 2507, the system receives a transaction confirmation for the transfer of the item. In some embodiments, the transaction confirmation may comprise receiving a payment from the second customer and/or receiving a record of a payment from the second customer to the first customer. In some embodiments, the payment may comprise a cryptocurrency (e.g. Bitcoin) transfer and the system may confirm the transaction by retrieving the transaction records from the cryptocurrency blockchain. In some embodiments, the transaction confirmation may be manually provided by the second customer. For example, the system may prompt the second customer to click a link, enter a confirmation code, scan the received product, scan a RFID tag, etc. at the completion of the transaction. In some embodiments, the system may track the GPS locations of user devices associated with the first and second customers to confirm that a meeting has taken place. In some embodiments, the system may further prompt the first and second customer to rate each other for the transaction.

In step 2508, the system provides a program incentive to the first customer in response to receiving the transaction confirmation. In some embodiments, the program incentive may comprise cash, store credit, gift card, digital currency, discount for future purchase, loyalty program points, etc. In some embodiments, a return shipping and/or restocking fee may be charged for items returned to a retailer but a customer returning the item through the resell program may receive a full refund as an incentive. In some embodiments, the system may place spending restrictions and/or caps on the program incentive to prevent abuse. In some embodiments, the system may provide program incentives only if the item is resold to a second customer selected by the system. In some embodiments, the system may restrict the number of items that a customer may sell through the resell program in a calendar period (e.g. month, quarter, year, etc.). In some embodiments, after step 2506, if the selected second customer does not accept the offer, the first customer may return to step 2505 and offer the item to a different potential buyer. In some embodiments, after step 2505, if the first customer is unable to find a second customer to purchase the item, the customer may elect to return the item through a conventional method (e.g. in-store, return shipping, etc.) or keep the item.

In some embodiments, the customers may be prompted to leave feedback for each other and/or the item. In some embodiments, after step 2508, the system may use the resell program transaction record and/or feedback to update the customer's customer profile in the customer database. In some embodiments, a system may simultaneously execute multiple instances of steps 2501-2508 for a plurality of customers and/or user devices.

With the process shown in FIG. 25, customers are offered an incentive to resell an item to another customer instead of returning the item to the retailer. The resell program may reduce the retailer's expense in handling reserve logistics while passing on the savings to the original customer and/or the secondary customer via incentive and/or price reduction.

Referring next to FIG. 26, a method for processing returns according to some embodiments is shown. The steps in FIG. 26 may generally be performed by a processor-based device such as a central computer system, a server, a cloud-based server, a customer order management system, a personal computer, a user device, etc. In some embodiments, the steps in FIG. 26 may be performed by one or more of the central computer system 2410 and the user device 2430 described with reference to FIG. 24 herein, and/or other similar devices.

In step 2601, the customer submits a return request. In some embodiments, the system may provide a customer user interface to the customer. In some embodiments, the customer user interface may be configured to display previous orders. The customer may then select one or more items in the displayed orders to indicate their intent to return the item(s). In some embodiments, the customer user interface may allow the customer to scan a barcode, scan a shipping slip, scan a Radio Frequency Identify (RFID) tag, capture an image, enter a description, etc. to identify the item(s) they wish to return.

In step 2602, the system determined whether the item entered in step 2601 is eligible for reselling through the resell program. In some embodiments, an item's eligibility for the resell program may be determined based on information associated with the particular item (e.g. expiration date, used), the item's category (e.g. perishable, electronics), and/or the purchase associated with the item (e.g. purchase date, payment method, etc.). If the item is not eligible for the resell program but is otherwise returnable, the process proceeds to step 2611 and the customer is offered the option to print a return shipping label and/or return the item to a store location. Once the customer returns the item, in step 2612, the system issues a refund to the customer. In some embodiments, a return shipping charge and/or a restocking fee may be deducted from the refund amount.

If the item being returned is determined to be eligible for the resell program in step 2602, the process proceeds to step 2621 and the system matches the product with potential buyers in the area. In some embodiments, the product may be matched to profiles and/or vectors of potential buyers within a geographic region associated with the first customer. In some embodiments, the matched buyer(s) may generally comprise customers who are determined to be likely to purchase the product from the original customer. In step 2622, the system displays one or more potential buyers who are determined to be good matches to the product in step 2621. In step 2623, the first customer contacts a potential buyer. In some embodiments, the system may provide a user interface through which sellers and buyers in the resell program may communicate with each other.

In step 2624, the system determines whether the potential buyer accepts the first customer's offer to resell the product. In some embodiments, the acceptance may be indicated by the first customer and/or the second customer. In step 2631, the customers arrange for a method and/or location for the transfer. In some embodiments, the system may recommend a transfer method, a meetup location, and/or a delivery agent based on customer profiles associated with the first customer and the second customer. In step 2632, the customers exchange the product and payment. In step 2633, the transfer is confirmed. In some embodiments, the transfer may be confirmed through transaction records and/or may be confirmed by the buyer. In step 2634, the system issues an incentive to the original customer. In some embodiments, the program incentive may comprise cash, store credit, gift card, digital currency, discount for future purchase, loyalty program points, etc.

In some embodiments, systems and methods are provided for handling return requests. In some embodiments, a retailer system provides a platform and tools to facilitate reverse logistics by the original customer. The platform may facilitate the reselling of items the customer wants to return to customers with value vectors that point to an affinity for the product. In some embodiments, the reverse logistic service may be offered for product categories with high return rates and may limit the handling of fragile items. The item may be directly transferred from the original buyer to the second buyer without going through the retailer. In some embodiments, the platform may match sellers and buyers in a local area such that the product may be tendered in-person. In some embodiments, a customer that resells the item to another customer instead of returning the item is offered a reduction in price or credit as an incentive.

In some embodiments, a system for handling return requests comprises a communication device configured to communicate with a plurality of user devices, a customer database storing customer profiles associated with a plurality of customers, a product database storing characteristics associated with a plurality of products, an order database, and a control circuit coupled to the communication device, the customer database, and the product database. The control circuit being configured to receive a request to return an item from a user device associated with a first customer, verify that the request to return the item complies with return restrictions based on information stored in the order database, retrieve customer profiles of a plurality of potential buyers from the customer database, determine alignments between the customer profiles of the plurality of potential buyers and product characteristics of the item stored in the product database, select a second customer from the plurality of potential buyers based on the alignments, facilitate a transfer of the item from the first customer to the second customer, receive a transaction confirmation for the transfer of the item, and provide a program incentive to the first customer in response to receiving the transaction confirmation.

In one embodiment, a method for handling return requests comprises receiving, at a control circuit and a communication device configured to communicate with a plurality of user devices, a request to return an item from a user device associated with a first customer, verifying, with the control circuit, that the request to return the item complies with return restrictions based on information stored in an order database, retrieving customer profiles of a plurality of potential buyers from a customer database storing customer profiles associated with a plurality of customers, determining, with the control circuit, alignments between the customer profiles of the plurality of potential buyers and product characteristics associated with the item stored in a product database storing characteristics associated with a plurality of products, selecting, with the control circuit, a second customer from the plurality of potential buyers based on the alignments, facilitating, with the control circuit, a transfer of the item from the first customer to the second customer, receiving, at a control circuit and via the communication device, a transaction confirmation for the transfer of the item, and providing, with the control circuit, a program incentive to the first customer in response to receiving the transaction confirmation.

In one embodiment, an apparatus for handling return requests, comprises a non-transitory storage medium storing a set of computer readable instructions and a control circuit configured to execute the set of computer readable instructions which causes to the control circuit to: receive, via a communication device configured to communicate with a plurality of user devices, a request to return an item from a user device associated with a first customer, verify that the request to return the item complies with return restrictions based on information stored in an order database, retrieve customer profiles of a plurality of potential buyers from a customer database storing customer profiles associated with a plurality of customers, determine alignments between the customer profile of the plurality of potential buyers and product characteristics associated with the item stored in a product database storing characteristics associated with a plurality of products, select a second customer from the plurality of potential buyers based on the alignments, facilitate a transfer of the item from the first customer to the second customer, receive, via the communication device, a transaction confirmation for the transfer of the item, and provide a program incentive to the first customer in response to receiving the transaction confirmation.

Systems and Methods for Processing Returns with a Smart Container

In some embodiments, systems, apparatuses, and methods are provided herein for processing returns with a container. A system for processing returns comprises a container housing comprising an access door to an item holding compartment, a return sensor configured to detect for returned items placed in the item holding compartment, a user interface device coupled to the container housing, a communication device configured to communicate with a customer database, and a control circuit coupled to the return sensor, the user interface device, and the communication device. The control circuit being configured to: detect a returned item returned by a customer via the return sensor, present a feedback prompt via the user interface device, receive a customer response to the feedback prompt via the user interface device, and update, via the communication device, a customer profile associated with the customer in the customer database based on the customer response.

Generally speaking, pursuant to various embodiments, systems, apparatuses and methods are provided herein for processing returns. In some embodiments, a system for processing returns comprises a container housing comprising an access door to an item holding compartment, a return sensor configured to detect for returned items placed in the item holding compartment, a user interface device coupled to the container housing, a communication device configured to communicate with a customer database, and a control circuit coupled to the return sensor, the user interface device, and the communication device. The control circuit being configured to: detect a returned item returned by a customer via the return sensor, present a feedback prompt via the user interface device, receive a customer response to the feedback prompt via the user interface device, and update, via the communication device, a customer profile associated with the customer in the customer database based on the customer response.

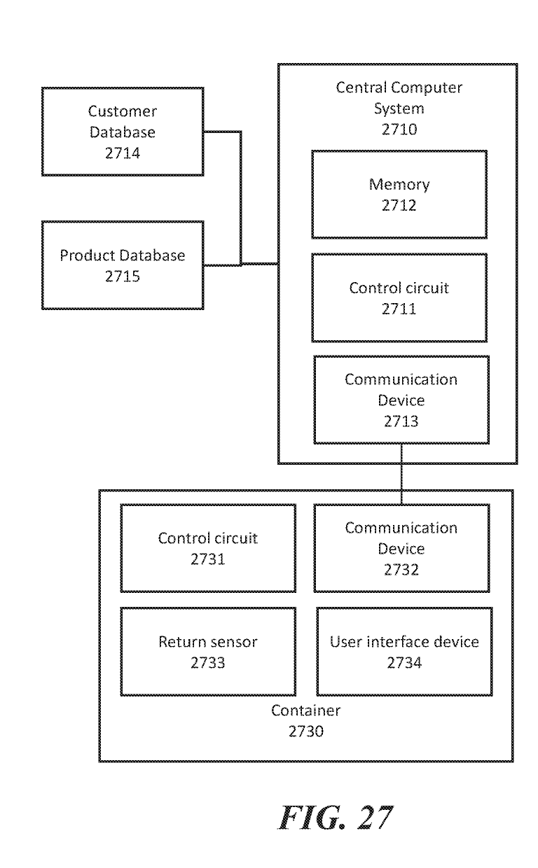

Referring next to FIG. 27, a block diagram of a system according to some embodiments is shown. The system comprises a central computer system 2710, a customer database 2714, a product database 2715, and a container 2730.

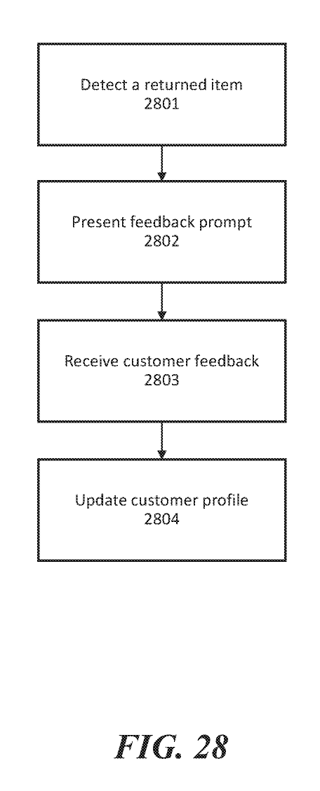

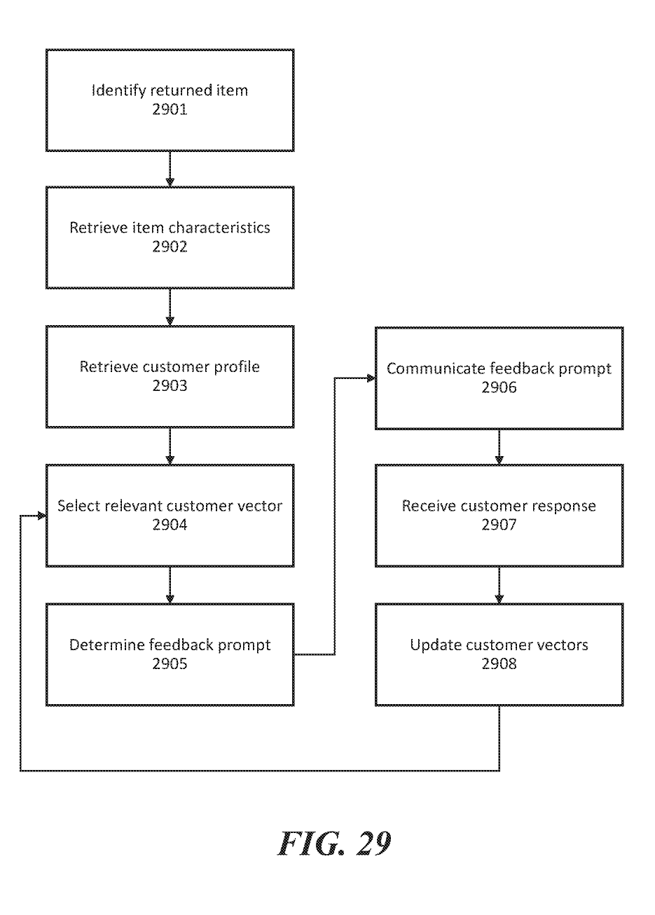

The central computer system 2710 may comprise a processor-based system such as one or more of a server system, a computer system, a cloud-based server, and the like. The central computer system 2710 comprises a control circuit 2711, a memory 2712, and a communication device 2713. The control circuit 2711 may comprise a processor, a central processor unit, a microprocessor, and the like. The memory 2712 may include one or more of a volatile and/or non-volatile computer readable memory devices. In some embodiments, the memory 2712 stores computer executable codes that cause the control circuit 2711 to process customer returns by communicating with the container 2730. In some embodiments, the control circuit 2711 may further be configured to determine feedback prompts for the container 2730 to communicate based on the information stored in the customer database 2714 and the product database 2715 and update customer profiles and/or vectors in the customer database 2714 based on customer responses received via the container 2730. In some embodiments, the computer executable code stored on the memory 2712 may cause the control circuit 2711 to perform one or more steps described with reference to FIGS. 28 and 29 herein.

The communication device 2713 is configured to allow the central computer system 2710 to communicate with one of more containers 2730 over a network. In some embodiments, the communication device 2713 may comprise one or more of a network adapter, a data port, a network port, a modem, a router, and the like. In some embodiments, the network may comprise one or more of the Internet, a public network, a private network, a secure network, a wireless data network, and the like. In some embodiments, the communication device 2713 may generally comprise one or more devices configured to allow the control circuit 2711 to exchange data with the control circuit 2731 of the container 2730. In some embodiments, the communication device 2713 may further allow the central computer system 2710 to access one or more of the customer database 2714 and the product database 2715.

The container comprises a control circuit 2731, a communication device 2732, a return sensor 2733, and a user interface device 2734. In some embodiments, the container 2730 may comprise a delivery receiving container configured to hold a plurality of delivered items for the customer. In some embodiments, the container 2730 may comprise a home delivery container such as a locked box placed near the customer's front door, on the porch, in the side yard, etc. In some embodiments, the container 2730 may comprise a shared delivery locker such as a locker at a supermarket, a convenience store, an apartment lobby, etc. that may be used by different customers at different times. In some embodiments, a customer may return products to the seller by leaving/placing the unwanted product in the container. A delivery person may then retrieve the products for reverse logistics. In some embodiments, the container 2730 may comprise one or more of a housing, an item holding compartment, and an access door. In some embodiments, the container 2730 may comprise a locking mechanism configured to prevent unauthorized access to the item holding compartment.

The control circuit 2731 of the container 2730 may comprise a processor, a central processor unit, a microprocessor, and the like. The container 2730 may comprise a memory device (not shown) which may include one or more of a volatile and/or non-volatile computer readable memory devices. In some embodiments, the memory stores computer executable codes that cause the control circuit 2731 to detect a return based on the return sensor 2733 and communicate with the customer via the user interface device 2734. In some embodiments, the control circuit 2731 may further be configured to determine feedback prompts for a return based on the information stored in the customer database 2714 and the product database 2715 and update customer profiles and/or vectors in the customer database 2714 based on customer responses. In some embodiments, the control circuit 2731 may be configured to perform one or more steps described with reference to FIGS. 28 and 29 herein.

The communication device 2732 of the container 2730 is configured to allow the container 2730 to communicate with the central computer system 2710, the customer database 2714, and/or the product database 2715 over a network. In some embodiments, the communication device 2732 may comprise one or more of a Wi-Fi transceiver, a mobile data transceiver, a Bluetooth transceiver, a network adapter, a data port, a network port, a modem, a router and the like. In some embodiments, the network may comprise one or more of the Internet, a public network, a private network, a secure network, a wireless data network, and the like. In some embodiments, the container 2730 may communicate with the central computer system 2710 via the customer's home network and/or via a customer device (e.g. smartphone, smart speaker, home Internet of Things (IoT) hub, etc. In some embodiments, the communication device 2732 may generally comprise one or more devices configured to allow the control circuit 2731 to exchange data with the control circuit 2711 of the central computer system 2710, the customer database 2714, and/or the product database 2715.

The return sensor 2733 comprises a sensor configured to detect for items being returned. In some embodiments, the return sensor 2733 may comprise one or more of a barcode scanner, an optically readable code scanner, a Radio Frequency Identification (RFID) reader, an optical sensor, an image sensor, a weight sensor, a lid sensor, etc. In some embodiments, the return sensor 2733 may sense for the motion of the container lid and/or items to determine that one or more items are being placed back into to the container after they have been removed. In some embodiments, the return sensor 2733 may monitor the content of the container to detect for items that are added to the container by the customer and/or left in the container by the customer. In some embodiments, the return sensor 2733 may form a sensor tunnel covering the opening of the container 2730 and be configured to detect for items entering and/or leaving the item holding compartment of the container 2730. In some embodiments, the customer may be instructed to scan items with the return sensor 2733 to initiate item return.

The user interface device 2734 comprises a device that allows the control circuit 2731 of the container 2730 to communicate information and collect responses from the customer. In some embodiments, the user interface device 2734 may comprise one or more user input/output devices such as a display screen, a touch screen, a speaker, a microphone, a motion sensor, etc. In some embodiments, the user interface device 2734 may be positioned on the exterior (e.g. top, front, side, etc.) of the container 2730, on the inside surface of the container access door, and/or inside the item holding compartment. In some embodiments, the user interface device 2734 may comprise a speaker and a microphone for having a voice conversation with the customer. In some embodiments, the user interface device 2734 may comprise a display device configured to display a graphical user interface (GUI) to the customer and receive input via the display and/or a separate touch input device.

In some embodiments, one or more of the control circuit 2731, the return sensor 2733, the user interface device 2734, and the communication device 2732 may be coupled to and/or integrated with the housing and/or the access door of the container 2730. In some embodiments, the container 2730 may further comprise a power source for supplying power to one or more of the control circuit 2731, the return sensor 2733, the user interface device 2734, and the communication device 2732. In some embodiments, the power source may comprise one or more of a power port, a rechargeable battery, a replaceable battery, a solar panel, a wireless charging pad, and the like. In some embodiments, the smart container 2730 may further comprise a locking mechanism for securing the content of the container from unauthorized access. For example, the container may comprise a locker and/or a cooler with a locking lid. In some embodiments, the user interface device 2734 may be used by the customer to unlock the container using a passcode, log-in credential, voice recognition, facial recognition, etc. In some embodiments, the smart container 2730 may comprise a temperature controlled storage unit such as a refrigerated locker.

The central computer system 2710 and/or the container 2730 may be coupled to a customer database 2714 and/or a product database 2715 via one or more wired and/or wireless communication channels. The customer database 2714 may be configured to store customer profiles for a plurality of customers. Each customer profile may comprise one or more of customer name, customer location(s), customer demographic information, customer configured preferences, customer purchase history, and customer vectors. Customer vectors may comprise one or more of a customer value vectors, customer partiality vectors, customer preference vectors, customer affinity vectors, and customer aspiration vectors described with reference to FIGS. 1-13 herein. In some embodiments, customer value vectors each comprises a magnitude that corresponds to the customer's belief in the good that comes from an order associated with that value. In some embodiments, customer vectors may each represent at least one of a person's values, preferences, affinities, and aspirations. In some embodiments, the customer value vectors each represents at least one of a person's values leading to at least one of a plurality of possible preferences and affinities and comprises a magnitude that corresponds to the customer's belief in good that comes from an order associated with that value. In some embodiments, the customer vectors may be determined and/or updated based on one or more of customer purchase history, customer survey input, customer reviews, customer item return history, customer return comments, and customer ratings, etc. In some embodiments, customer profiles and/or customer vectors may be determined and/or updated based on customer responses provided through the user interface device 2734 of the container 2730. In some embodiments, customer vectors determined from a customer's purchase history and comments associated with one or more product categories may be used to match the customer to a product in a category from which the customer has not previously made a purchase. For example, customer vectors determined from the customer's purchase of snacks and pet foods may indicate that the user values natural products. The customer vector and magnitude associated with natural products may then be used to match the customer to products in the beauty and personal care categories.

The product database 2715 may store one or more profiles of products offered for sale. In some embodiments, a product profile may comprise one or more of product category, product specification, product price, product characteristics, product return restrictions, etc. In some embodiments, the product profiles may associate vectorized product characterizations with products for sale. In some embodiments, the vectorized product characterizations may comprise one or more vectors associated with customer values, preferences, affinities, and/or aspirations in reference to the products. For example, a product profile may comprise vectorized product value characterization that includes a magnitude that corresponds to how well the product aligns with a customer's cruelty-free value vector. In some embodiments, the vectorized product characterizations may be determined based on one or more of product packaging description, product ingredients list, product specification, brand reputation, and customer feedback. In some embodiments, the product database 2715 may store other information about the product, such as product price, product storage location, product availability, product origin location, product ingredients, etc. In some embodiments, for products with unique identifiers (e.g. RFID tag, serial number, etc.), the product database 2715 and/or an order database may store item-specific information such as date of purchase, expiration date, etc.

While the customer database 2714 and the product database 2715 are shown to be outside the central computer system 2710 and the container 2730 in FIG. 27, in some embodiments, the customer database 2714, the product database 2715, and/or the order database may be implemented as part of the central computer system 2710 and/or the container 2730. In some embodiments, the customer database 2714 and the product database 2715 may comprise one or more server-based and/or cloud-based storage databases accessible by the central computer system 2710 and/or the container 2730 through network connections. In some embodiments, the customer database 2714 and the product database 2715 comprise database structures that represent customer values and product characteristics, respectively, in vector form.

In some embodiments, one or more functions of the central computer system 2710 described herein may be performed by the container 2730 and the central computer system 2710 may be omitted. For example, the container 2730 may be configured to collect customer responses without communicating with a central computer system and directly communicate with the customer database 2714 to update customer profiles. In some embodiments, the container 2730 may store a customer's profile and product characteristics associated with recently purchased items and determine return feedback prompts based on locally stored information. While one container 2730 is shown, in some embodiments, the central computer system 2710, the customer database 2714, and the product database 2715 may be configured to simultaneously communicate and support a plurality of containers 2730 in processing returns.

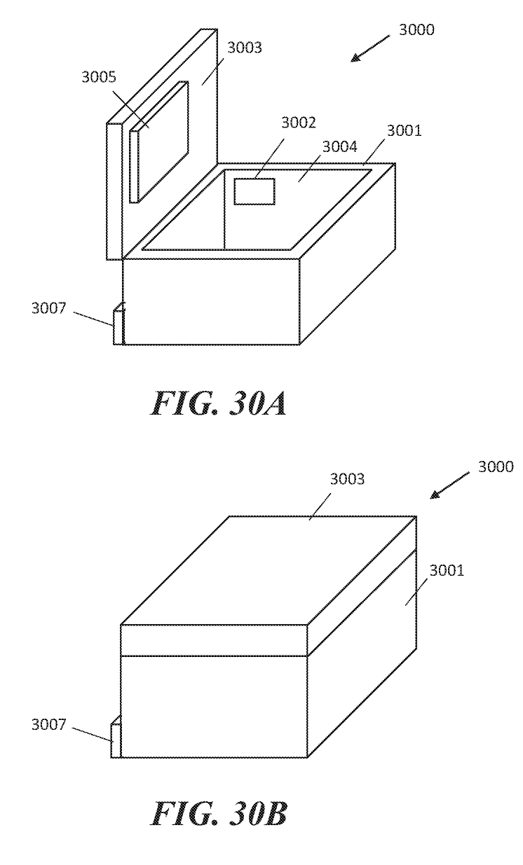

Referring next to FIG. 28, a method for processing returns according to some embodiments is shown. The steps in FIG. 28 may generally be performed by a processor-based device such as a smart container, a central computer system, a server, a cloud-based server, an order management system, a personal computer, a user device, etc. In some embodiments, the steps in FIG. 28 may be performed by one or more of the central computer system 2710 and/or the container 2730 described with reference to FIG. 27 herein, the container 3000 described with reference to FIGS. 30A and 30B, and/or other similar devices.

In step 2801, the system detects a returned item returned by a customer via a return sensor. In some embodiments, the return sensor may comprise one or more of a barcode scanner, an optically readable code scanner, a Radio Frequency Identification (RFID) reader, an optical sensor, an image sensor, and a weight sensor. In some embodiments, the return sensor may sense the motion of the container access door and/or items to determine that one or more items are being placed back into to the container after they have been removed. In some embodiments, the return sensor may monitor the content of the container to detect for items that are added to the container by the customer and/or left in the container by the customer. In some embodiments, the return sensor may form a sensor tunnel covering the opening of the container and configured for detect for items entering and/or leaving the item holding compartment of the container. In some embodiments, the customer may be instructed to scan items with the return sensor to initiate item return. In some embodiments, the return sensor may comprise the return sensor 2733 described with reference to FIG. 27, the return sensor 3002 described with reference to FIG. 30A, or similar devices. In some embodiments, one or more of the container's user interface device and the communication device may be powered on in response to step 2801. In some embodiments, the container may be configured to process returns for items delivered to the customer through an automatic delivery service and not specifically selected by the customer for purchase. In some embodiments, the container may be configured to process returns for items purchased through an online order, a home delivery order, an in-store purchase, a store pickup purchase, etc.

In step 2802, the container presents a feedback prompt to the customer via a user interface device coupled to the container. In some embodiments, the user interface device may comprise one or more of a display screen, a touch screen, a speaker, a microphone, a motion sensor, and the like. In some embodiments, the user interface device may comprise a speaker and the feedback prompt may comprise spoken audio. In some embodiments, the user interface device may comprise a display device and the feedback prompt may be displayed as text and/or images. In some embodiments, the feedback prompt may generally ask the customer to comment on the product being return (e.g. “what did you not like about this product?”). In some embodiments, the feedback prompt may be selected based on the customer's profiles and/or characteristics of the product being returned. For example, if an organic soap bar is being returned by the customer, the feedback prompt may ask the customer “do you prefer organic personal care products?” based on the product's characteristics. In some embodiments, the feedback prompt may ask the customer to rate one or more characteristics of the product and/or how much they value one or more characteristics of the product. In some embodiments, preconfigured feedback prompts may be associated different characteristics of products and/or customers. Examples of a process for determining the feedback prompt are described with reference to FIG. 29 herein.

In step 2803, the system receives a customer response to the feedback prompt via the user interface device. In some embodiments, the customer response may comprise a spoken response and the system may perform voice recognition on the response. For example, the customer may say “the price is too high,” “I don't like the scent,” etc. In some embodiments, the customer's spoken response may be processed using a natural language processing (NLP) software. In some embodiments, the system may comprise one or more NLP programs, including open source and/or commercially available products such as Stanford's Core NLP Suite, SpaCy by MIT, Natural Language Toolkit for Python, Apache Lucene and Solr, Apache OpenNLP, Salience and Semantria API by Lexalytics, and similar products. In some embodiments, the system may analyze for one or more customer and/or product characteristics mentioned in the customer's spoken response. In some embodiments, customer and/or product characteristics may be identified through keyword detection and/or pattern analysis. In some embodiments, the system may then determine whether the response constitutes a positive, neutral, or negative response to the identified characteristic based on NLP. In some embodiments, the system may specify a characteristic in the feedback prompt and ask the customer to rate the importance of the characteristic. In some embodiments, the customer response may comprise a touch input and/or a gesture, and the system may match a response to the customer selection. For example, the system may ask the customer to rate one or more characteristics of the product by touching 1-5 starts on the screen, and the customer input may comprise the customer's touch input response.

In step 2804, the system updates a customer profile associated with the customer in the customer database based on the customer response. In some embodiments, the system may associate the response with one or more customer characteristics. For example, if the customer response mentions product pricing, the customer profile may be updated to indicate that the customer is budget-conscious and/or refine the acceptable price range for the customer. In another example, if the customer response indicates that an item is being returned for not being organic, the customer profile may be updated to reflect that the customer values organic products. In some embodiments, the feedback prompt may be configured to solicit a response associated with a characteristic of the customer and/or the product (e.g. “was it important to you that this product is made of recycled material?”) and the corresponding characteristic may be updated in the customer's profile based on whether the customer's response was positive or negative (e.g. “yes” or “no”). Examples of a process for updating the customer profile are described with reference to FIG. 29 herein.

In some embodiments, steps 2802-2804 may be repeated a number of times for a returned item to cover different characteristics of the product and/or the customer. In some embodiments, the customer may request to speak to a customer care personnel via the smart container. The system may then connect the customer with a remote customer care personnel via the user interface device and the communication device of the smart container. In some embodiments, the system may further be configured to automatically provide the customer profile to the remote customer care personnel via a customer care personnel user interface and device in response to the customer's request. In some embodiments, a smart container may be configured to perform one or more of steps 2801-2804 without active communication with a remote server. In some embodiments, a central server may support the smart container by determining a feedback prompt based on the item identified by the smart container and/or updating the customer profile based on the response received at the smart container.

Referring next to FIG. 29, a method for processing returns according to some embodiments is shown. The steps in FIG. 29 may generally be performed by a processor-based device such as a smart container, a central computer system, a server, a cloud-based server, an order management system, a personal computer, a user device, etc. In some embodiments, the steps in FIG. 29 may be performed by one or more of the central computer system 2710 and/or the container 2730 described with reference to FIG. 27 herein, the container 3000 described with reference to FIGS. 30A and 30B, and/or other similar devices.

In step 2901, the system identifies the returned item. In some embodiments, a smart container may comprise a return sensor configured to detect that an item is being returned and read an identifier on the item. In some embodiments, the return sensor may comprise one or more of a barcode scanner, an optically readable code scanner, a Radio Frequency Identification (RFID) reader, an optical sensor, an image sensor, and a weight sensor. In some embodiments, the item may be identified based on the item's bar code, Radio Frequency RFID tag, markings, etc. as detected by the return sensor. In some embodiments, the system may further compare the information captured the return sensor with one or more orders associated with the customer to identify the item. In some embodiments, the return sensor may comprise the return sensor 2733 described with reference to FIG. 27, the return sensor 3002 described with reference to FIG. 30A, or similar devices. In some embodiments, one or more of the container's user interface device and the communication device may be turned on in response to step 2901. In some embodiments, the container may be configured to process returns for items delivered to the customer through an automatic delivery service and not specifically selected by the customer for purchase. In some embodiments, the container may be configured to process returns for items purchased through an online order, a home delivery order, an in-store purchase, a store pickup purchase, etc.

In step 2902, the system retrieves item characteristics associated with the returned item from a product database. The product database may store one or more profiles of products offered for sale. In some embodiments, product characteristics may comprise one or more product name, product brand, product labels, product description, product certification, product manufacturer, product material, product ingredients, product price, etc. In some embodiments, the product purchase price and purchase date may be recorded in an order database storing customer orders. In some embodiments, the product profiles may associate vectorized product characterizations with products for sale. In some embodiments, the vectorized product characterizations may comprise one or more of vectors associated with customer values, preferences, affinities, and/or aspirations in reference to the products. For example, a product profile may comprise vectorized product value characterization that includes a magnitude that corresponds to how well the product aligns with a customer's cruelty-free value vector. In some embodiments, the vectorized product characterizations may be determined based on one or more of product packaging description, product ingredients list, product specification, brand reputation, and customer feedback. In some embodiments, for products with unique identifiers (e.g. RFID tag, serial number, etc.), the product database and/or an order database may store item-specific information such as date of purchase, expiration date, etc.

In step 2903, the system retrieves a customer profile associated with the customer from the customer database. The customer database may be configured to store customer profiles for a plurality of customers. Each customer profile may comprise one or more of customer name, customer location(s), customer demographic information, customer configured preferences, customer purchase history, and customer vectors. Customer vectors may comprise one or more of a customer value vectors, customer partiality vectors, customer preference vectors, customer affinity vectors, and customer aspiration vectors. In some embodiments, customer value vectors each comprises a magnitude that corresponds to the customer's belief in the good that comes from an order associated with that value. In some embodiments, customer vectors may each represent at least one of a person's values, preferences, affinities, and aspirations. In some embodiments, the customer value vectors each represents at least one of a person's values leading to at least one of a plurality of possible preferences and affinities and comprises a magnitude that corresponds to the customer's belief in good that comes from an order associated with that value. In some embodiments, the customer vectors may be determined and/or updated based on one or more of customer purchase history, customer survey input, customer reviews, customer item return history, customer return comments, and customer ratings, etc. In some embodiments, customer profiles and/or customer vectors may be determined and/or updated based on customer responses provided in step 2907. In some embodiments, customer vectors determined from a customer's purchase history and comments associated with one or more product categories may be used to match the customer to a product in a category from which the customer has not previously made a purchase. For example, customer vectors determined from the customer's purchase of snacks and pet foods may indicate that the user values natural products. The customer vector and magnitude associated with natural products may then be used to match the user to products in the beauty and personal care categories.

In step 2904, the system selects one or more relevant customer vectors from the customer profile based on comparing the customer vectors associated with the customer and the item characteristics associated with the returned item. In some embodiments, the relevant customer vectors may be determined based on determining alignments between customer vectors and product characteristics. In some embodiments, the alignments between a vectorized product characteristic and a customer vector may be determined by adding, subtracting, multiplying, and/or dividing the magnitudes of the corresponding vectors. For example, the product's environmental friendliness characteristic vector may be compared with the customer's environmental friendliness vector to determine how well the vectors are well aligned (e.g. have similar magnitudes). In some embodiments, the system may select the vectors with the highest alignment in step 2904. In some embodiments, the system may only consider the prominent vectors (e.g. high magnitude vectors) associated with the customer or the product in determining the alignment. For example, the relevant customer vectors may only comprise customer vectors with at least a threshold magnitude. Generally, the relevant customer vectors may comprise vectors that are well matched with characteristics of the product. In some embodiments, one or more steps 2902 and 2903 may be performed when products in an automatic delivery order service are selected for a customer. For example, the system may perform steps 2902 and 2903 to select products that the customer has not specifically ordered to ship to the customer. The relevant customer vectors associated with each product may then be stored with the order in an order database. In such cases, the system may use the information stored in the order to perform step 2905.

In step 2905, the system determines the content of the feedback prompt based on the one or more relevant customer vectors. In some embodiments, the feedback prompt identifies at least one of the one or more relevant customer vectors and solicits a feedback related to the at least one of the one or more relevant customer vectors. In some embodiments, preconfigured feedback prompts may be associated with different characteristics of products and/or customers. For example, if the customer vector associated with sustainability is selected in step 2904, the system may ask “was it important to you that the product is made of sustainable material?” In some embodiments, feedback prompts may comprise template questions that may be filled with customer vector and/or product characteristic descriptions. For example, the question template may comprise “is it important to you that products are [insert product characteristic]?” and/or “is it [insert customer vector] a factor in your decision to return this product?” In some embodiments, the feedback prompt may further be configured to mention the product and/or the customer (e.g. “John, did you know that this A-brand coffee is fair-trade certified?). In some embodiments, the feedback prompt may prompt the customer to rate the importance of the relevant customer vector (e.g. “on a scale of 1-5, how much does the durability of an item affect your purchase decision?”). In some embodiments, the system may determine and communicate a plurality of feedback prompts each associated with a different customer value. For example, if five customer vectors are selected in step 2904, the system may select five different feedback prompts each targeted to solicit a response for each vector.

In step 2906, the system communicates the feedback prompt to the customer via a user interface device coupled to the container. In some embodiments, the user interface device may comprise one or more of a display screen, a touch screen, a speaker, a microphone, and a motion sensor. In some embodiments, the user interface device may be positioned on the exterior (e.g. top, front, side, etc.) of the container, on the inside surface of the container lids, and/or inside the item holding compartment. In some embodiments, the user interface device may comprise a speaker and the feedback prompt may comprise spoken audio. In some embodiments, the user interface device may comprise a display device and the feedback prompt may be displayed as text and/or images.

In step 2907, the system receives a customer response to the feedback prompt via the user interface device on the container. In some embodiments, the customer response may comprise a spoken response and the system may perform voice recognition on the response. For example, the customer may say “the price is too high,” “I don't like the scent,” etc. In some embodiments, the customer's spoken response may be processed using a natural language processing (NLP) software. In some embodiments, the system may comprise one or more NLP programs, including open source and/or commercially available products such as Stanford's Core NLP Suite, SpaCy by MIT, Natural Language Toolkit for Python, Apache Lucene and Solr, Apache OpenNLP, Salience and Semantria API by Lexalytics, and similar products. In some embodiments, the system may determine whether the response constitutes a positive, neutral, or negative response to the relevant customer vector based on NLP. In some embodiments, the customer response may comprise a touch input and/or a gesture, and the system may match a response to the customer selection. In some embodiments, the display device may display the relevant customer vectors and ask the customer to rate each vector and/or select the vectors that are relevant to their decision to return a product.

In step 2908, the system updates the customer profile associated with the customer in the customer database based on the customer response. In some embodiments, the update to the customer profile comprises increasing a magnitude of a relevant customer vector or decreasing the magnitude of the relevant customer vector associated with the feedback prompt determined in step 2905. For example, if the question prompt is configured to solicit a response regarding the customer vector for product durability, the system may update the customer vector associated with durability in step 2908. In some embodiments, the magnitude of the customer vector may be increased if the customer provides a positive response to the question prompt and the magnitude of the customer value may be decreased if the customer provides a negative response to the feedback prompt. In some embodiments, if the customer indicates that an item characteristic identified in the feedback prompt is important, but the product is being returned for other reasons, the customer vector associated with the product characteristic may remain unchanged. In some embodiments, the update to the customer profile may be determined further based on item characteristics of the returned item stored in a product database. For example, if the product has a moderate magnitude on sustainability and the customer indicates that the product is being returned for not being sustainable, the system may increase the customer's vector for sustainability such that only products with high sustainability ratings are matched with the customer in the future. In some embodiments, the customer's response may comprise a change of mind (e.g. decision to not return the product). For example, the system may configure a feedback prompt based on the product's return policy and communicate to the customer “do you know that this product also has a 30-day risk-free return guarantee?” If the customer decides to keep the product after the prompt, the system may increase the customer's value vector associated with purchase flexibility. In some embodiments, steps 2904-2908 may be repeated for each of the customer vectors selected in step 2904. In some embodiments, the customer vector updated in step 2908 may correspond to the relevant customer vector selected in step 2904.

As an example, a smartwatch return may be processed according to the steps of FIG. 29 as follows. In step 2901, the system identifies that a smartwatch has been placed into a smart container based on the packaging's optical code, RFID tag, etc. In step 2902, the system may retrieve the smartwatch's characteristics from a product database. The characteristics may comprise the smartwatch's specification (e.g. design, features, battery life, weight, etc.), manufacturer information, purchase price, purchase date, etc. In step 2903, the system retrieves the customer's profile. In some embodiments, the customer profile may be associated with the owner of the smart container. In some embodiments, if more than one customer shares a smart container, the system may look for the smartwatch in orders delivered to the container to select the customer profile associated with the order. In step 2904, the system selects the relevant customer vectors. In some embodiments, the relevant customer vectors may comprise customer vectors that are well aligned with the smartwatch's characteristics. In some embodiments, the relevant customer vectors may comprise the vectors initially used to select the smartwatch for the customer. For example, for a smartwatch, the relevant customer vectors may comprise a healthy lifestyle value vector, a budget consciousness vector, and a preference for devices compatible with another customer-owned device (e.g. Google Home controller). In step 2905, the system may select one or more customer vectors selected in step 2904 to configure a feedback prompt. For example, the system may first ask “do you know this smartwatch is natively compatible with your Google Home controller?” in step 2906. If the customer responds with “that's not important to me, I already have a watch” in step 2907, the system may decrease the magnitude of the customer's preference vector for Google Home compatible devices in step 2908. The system may then return to step 2904 and select a different customer vector. For example, in step 2905, the system may follow up with “do you know that it has a heart rate monitor for fitness tracking?” If the customer responds by asking more about the fitness feature or keeping the product, the customer vector associated with healthy living may be increased based on the customer's interest in step 2908. In some embodiments, steps 2904-2908 may be repeated for every relevant customer vector, for a set number of relevant customer vectors (e.g. 3, 5, etc.), or until the customer terminates the communication by closing the container lid, walking away, or removing the product from the container to indicate that they intend to keep the product instead.

In some embodiments, the customer may request to speak a customer care personnel via the smart container anytime during steps 2901-2908. The system may then connect the customer with a remote customer care personnel via the user interface device and the communication device. In some embodiments, the system may automatically provide the customer profile to the remote customer care personnel via a customer care personnel user interface device. In some embodiments, the customer profile may include and/or highlight the relevant customer vectors selected in step 2904. In some embodiments, a smart container may be configured to perform one or more of steps 2901-2908 without actively communicating with a remote server. For example, the smart container may store customer vectors associated with the owner of the container and product vectors associated with recently purchased/delivered products, and perform one or more of steps 2901-2908 with locally stored data. In some embodiments, a central server may be configured to perform one or more of steps 2901-2908 with communication with the container. For example, an item identifier may be transmitted from the smart container to a central system for identification and the central computer system may determine the feedback prompt for the smart container to communicate. The received response may then be transmitted back to the central server for processing to determine how the customer profile should be updated.

Referring next to FIGS. 30A and 30B, illustrations of a smart container according to some embodiments is shown. The smart container 3000 comprises a housing 3001, an item holding compartment, an access door 3003, a return sensor 3002, a control unit 3007, and a user interface device 3005. In some embodiments, the container 3000 may comprise a home delivery container such as a locked box placed by the customer's front door, on the porch, in the side yard, etc. In some embodiments, the container 3000 may comprise a shared delivery locker such as a locker at a supermarket, a convenience store, an apartment lobby, etc. that may be used by different customers at different times. In some embodiments, a customer may return products they wish to return and/or do not wish to purchase by leaving/placing the unwanted product in the container. A delivery person may then retrieve the products for reverse logistics. FIG. 30A illustrates a view of the smart container 3000 with the access door 3003 open and FIG. 30B illustrates a view of the smart container 3000 with the access door 3003 close.

The housing 3001 of the smart container 3000 may generally comprise a rigid material that encloses the content of the item holding compartment 3004. In some embodiments, the housing 3001 may comprise insulated walls. The access door 3003 comprises a portion of the housing 3001 configured to be opened to provide access to the item holding compartment 3004 and closed to secure the content. While a top-open lid is shown in FIGS. 30A and 30, in some embodiments, the access door 3003 may comprise a side-open door, a swing door, a sliding door, a retractable door, etc. In some embodiments, the housing 3001 and the access door 3003 may further comprise a locking mechanism for securing items in the item holding compartment. In some embodiments, the locking mechanism may comprise mechanical and/or magnetic locks for locking and releasing the access door 3003.

The return sensor 3002 may comprise a sensor configured to detect for items being returned. In some embodiments, the return sensor 3002 may comprise one or more of a barcode scanner, an optically readable code scanner, a Radio Frequency Identification (RFID) reader, an optical sensor, an image sensor, and a weight sensor. In some embodiments, the return sensor 3002 may sense for the motion of the container lid and/or items to determine that one or more items are being placed back into to the container by a customer. In some embodiments, the return sensor 3002 may monitor the content of the container to detect for items that are added to the container by the customer and/or left in the container by the customer. In some embodiments, the return sensor 3002 may form a sensor tunnel covering the opening of the item holding compartment 3004 and configured to detect for items entering and/or leaving the smart container 3000. In some embodiments, the customer may be instructed to scan items by holding the item near the return sensor 3002 to initiate the item return process. The location of the return sensor 3002 is provided as an example only. In some embodiments, the return sensor may be positioned on a different wall of the item holding compartment 3004, on the rim of the item holding compartment 3004, on the access door 3003, and/or on the exterior of the housing 3001. In some embodiments, the smart container 3000 may comprise a plurality of return sensors 3002 located at one or more locations.

The user interface device 3005 comprises a device that allows the controls of the smart container 3000 to communicate information and collect responses from customers. In some embodiments, the user interface device 3005 may comprise one or more user input/output devices such as a display screen, a touch screen, a speaker, a microphone, a motion sensor, etc. In FIG. 30A, the user interface device 3005 is shown to be positioned on the inside surface of the access door 3003 such that the customer may use the user interface device 3005 while the access door is open. In some embodiments, the user interface device 3005 may be positioned on the exterior (e.g. top, front, side, etc.) of the housing 3001, on the top surface of the access door 3003, and/or on a wall of the item holding compartment 3004. In some embodiments, the user interface device 3005 may comprise a display device configured to display a graphical user interface (GUI) to the customer and receive input via the display. In some embodiments, the user interface device 3005 may comprise a speaker and a microphone for having a voice conversation with the customer. In some embodiments, the user interface device 3005 may be integrated into the structure of the housing 3001 and/or the access door 3003 of the smart container 3000.

The control unit 3007 of the smart container 3000 may comprise one or more of a control circuit, a memory device, a communication device, and a power source. The control circuit may comprise a processor, a central processor unit, a microprocessor, and the like. The memory device may include one or more of a volatile and/or non-volatile computer readable memory devices and may store computer executable codes that cause the control circuit to detect a return based on the return sensor 3002 and process customer returns via the user interface device 3005. In some embodiments, the control circuit may further be configured to determine feedback prompts based on the returned item and update customer profiles and/or vectors in a customer database based on customer responses. In some embodiments, the control circuit may be configured to perform one or more steps described with reference to FIGS. 28 and 29 herein.

The communication device of the control unit 3007 may be configured to allow the container 3000 to communicate with a central computer system, a customer database, and/or a product database over a network. In some embodiments, the communication device may comprise one or more of a Wi-Fi transceiver, a mobile data transceiver, a Bluetooth transceiver, a network adapter, a data port, a network port, a modem, a router and the like. In some embodiments, the network may comprise one or more of the Internet, a public network, a private network, a secure network, a wireless data network, and the like. The power source may be configured to provide power to one or more of the control unit 3007, the return sensor 3002, the user interface device 3005, and the communication device. In some embodiments, the power source may comprise one or more of a power port, a rechargeable battery, a replaceable battery, a solar panel, a wireless charging pad, and the like. In some embodiments, the control unit 3007 may be integrated with the housing 3001 of the smart container 3000 and may not be visually distinguishable from the housing 3001. In some embodiments, the control unit 3007 may further comprise a temperature regulator (e.g. refrigerator, freezer) for affecting the temperature inside the item holding compartment 3004.

The illustration of the smart container 3000 is provided as an example only. In some embodiments, the placement, shape, proportion, dimension, and orientation of one or more of the housing 3001, the return sensor 3002, the user interface device 3005, the access door 3003, and the control unit 3007 may be variously configured without departing from the spirit of the present disclosure

In some embodiments, after a customer receives a delivery via a smart container, the customer may first take everything out of the container and return unwanted items back into the container. When returned items are detected, the container may initiate a conversation with the customer by asking “returning item?” If the customer responds ‘yes” the container may then ask “why?” After receiving the customer's explanation of the return, the smart container may ask for further clarifications based on or more characteristics of the product and/or the customer's profile. In some embodiments, the customer may end the conversation at any time. For example, the customer may close the container to end the conversation. In some embodiments, the customer's responses may be used to determine/update value vectors for customers. In some embodiments, a smart container may comprise one or more of a container portion, a lid, a lid sensor, a return sensor, a speaker, and a microphone for voice recognition. In some embodiments, the return sensor may comprise one or more of a RFID scanner, a camera, and/or a QR code reader.

In some embodiments, a system for processing returns comprises a container housing comprising an access door to an item holding compartment, a return sensor configured to detect for returned items placed in the item holding compartment, a user interface device coupled to the container housing, a communication device configured to communicate with a customer database, and a control circuit coupled to the return sensor, the user interface device, and the communication device. The control circuit being configured to: detect a returned item returned by a customer via the return sensor, present a feedback prompt via the user interface device, receive a customer response to the feedback prompt via the user interface device, and update, via the communication device, a customer profile associated with the customer in the customer database based on the customer response.

In one embodiment, a method for processing returns comprises detecting, via a return sensor, that a returned item has been placed, by a customer, into an item holding compartment of a container housing comprising an access door, present a feedback prompt via a user interface device coupled to the container housing, receive a customer response to the feedback prompt via the user interface device, and update, via a communication device coupled to the user interface device, a customer profile associated with the customer stored in a customer database based on the customer response.

In one embodiment, a system for processing returns, comprises a container housing comprising an access door to an item holding compartment, a return sensor configured to detect for returned items placed in the item holding compartment, a user interface device coupled to the container housing, a communication device configured to communicate with a product database and a customer vectors database, and a control circuit coupled to the return sensor, the user interface device, and the communication device, the control circuit being configured to: identify a returned item returned by a customer via the return sensor, retrieve, via the communication device, item characteristics associated with the returned item from the product database, retrieve, via the communication device, customer vectors associated with the customer from the customer vectors database, select one or more relevant customer vectors from the customer vectors based on comparing the customer vectors associated with the customer and the item characteristics associated with the returned item, determine a message associated with the one or more relevant customer vectors, communicate the message to the customer via the user interface device, receive a customer response to the message via the user interface device; and update the customer vectors associated with the one or more relevant customer vectors in the customer vectors database based on the customer response.

In some embodiments, a system for the return of items is described herein that includes a control circuit and a database accessible by the control circuit and configured to store data therein corresponding to delivery agents. The control circuit is configured to: receive a return message from a first customer for an item purchased from a store, the first customer being located at a first location, generate a transfer request for delivery of the item from the first location to a second location, send the transfer request to one or more of the delivery agents based on data retrieved from the database, receive an acceptance message from a delivery agent of the one or more delivery agents indicating that the delivery agent will pick up the item at the first location and deliver the item to a second location, send route information to the delivery agent regarding the first and second locations, receive a confirmation message in response to successful delivery of the item to the second location, and process a return for the first customer in response to receiving the confirmation message.

By some approaches, the second location can be a location of the store. By several approaches, the control circuit can further be configured to receive a purchase message from a second customer for the item and the second location can be a location of the second customer.

By several approaches, the control circuit can further be configured to retrieve value information for a second customer from the database, where the value information indicates at least one partiality possessed by the second customer for the item. In these approaches, the second location can be a location of the second customer. By further approaches, delivery to the second location is not pursuant to a previously approved purchase transaction of the second customer.

By some approaches, the control circuit can further be configured to: determine whether a second customer in a predetermined area surrounding the first location has value information indicating at least one partiality possessed by the second customer for the item and send a message to the delivery agent indicating that the item is payment for the item pick up in response to determining that no second customer has the value information.

By several approaches, the return message can be an exchange message where the transfer request includes a transfer request for a second item to the first location and the acceptance message further indicates that the delivery agent will pick up the second item and deliver the second item to the first location.

By some approaches, the control circuit can be configured to receive a plurality of return messages from a plurality of customers for a plurality of items purchased from the store, the plurality of customers being located at a plurality of locations. By these approaches, the control circuit can be configured to generate a transfer request for the plurality of items to the second location.

In several embodiments, a method for returning items is described herein that includes receiving a return message at a control circuit from a first customer for an item purchased from a store, the first customer being located at a first location, generating a transfer request with the control circuit for delivery of the item from the first location to a second location, sending the transfer request with the control circuit to one or more delivery agents based on delivery agent data retrieved from a database, receiving an acceptance message at the control circuit from a delivery agent of the one or more delivery agents indicating that the delivery agent will pick up the item at the first location and deliver the item to a second location, sending route information with the control circuit to the delivery agent regarding the first and second locations, receiving a confirmation message at the control circuit in response to successful delivery of the item to the second location, and processing a return for the first customer with the control circuit in response to receiving the confirmation message.

By some approaches, generating the transfer request for delivery of the item from the first location to the second location can include generating a transfer request for delivery of the item from the first location to a location of the store.

By several approaches, the method can further include receiving a purchase message from a second customer for the item; and wherein generating the transfer request for delivery of the item from the first location to the second location comprises generating a transfer request for delivery of the item from the first location to a location of the second customer.

By some approaches, the method can further include retrieving value information for a second customer from the database, the value information indicating at least one partiality possessed by the second customer for the item; and wherein generating the transfer request for delivery of the item from the first location to the second location comprises generating a transfer request for delivery of the item from the first location to a location of the second customer By further approaches, delivery to the second location is not pursuant to a previously approved purchase transaction of the second customer.

By several approaches, the method further includes: determining whether a second customer in a predetermined area surrounding the first location has value information indicating at least one partiality possessed by the second customer for the item; and sending a message to the delivery agent indicating that the item is payment for the item pick up in response to determining that no second customer has the value information.

By some approaches, receiving the return message from the first customer for the item purchased from the store includes receiving an exchange message from the first customer to exchange a second item for the item purchased from the store; and generating the transfer request for delivery of the item from the first location to the second location further includes generating a transfer request for delivery of the second item to the first location.

By several approaches, wherein receiving the return message from the first customer for the item purchased from the store, the first customer being located at the first location, can include receiving a plurality of return messages from a plurality of customers for a plurality of items purchased from the store, the plurality of customers being located at a plurality of locations; and generating the transfer request for delivery of the item from the first location to the second location includes generating a transfer request for delivery of the plurality of items from the plurality of locations to the second location.

In some embodiments, a system for handling return requests comprises a communication device configured to communicate with a plurality of user devices, a customer database storing customer profiles associated with a plurality of customers, a product database storing characteristics associated with a plurality of products, an order database, and a control circuit coupled to the communication device, the customer database, and the product database. The control circuit being configured to: receive a request to return an item from a user device associated with a first customer, verify that the request to return the item complies with return restrictions based on information stored in the order database, retrieve customer profiles of a plurality of potential buyers from the customer database, determine alignments between the customer profiles of the plurality of potential buyers and product characteristics of the item stored in the product database, select a second customer from the plurality of potential buyers based on the alignments, facilitate a transfer of the item from the first customer to the second customer, receive a transaction confirmation for the transfer of the item, and provide a program incentive to the first customer in response to receiving the transaction confirmation.

In some embodiments, the customer profiles comprise customer value vectors, the customer value vectors each represents at least one of a person's values leading to at least one of a plurality of possible preferences and affinities and each comprises a magnitude that corresponds to the customer's belief in good that comes from an order associated with that value. In some embodiments, the control circuit is further configured to relay messages between the first customer and the second customer. In some embodiments, the control circuit is further configured to facilitate a payment from the second customer to the first customer, the payment comprises one or more of an in-person payment, a peer-to-peer electronic payment transfer, a digital currency transfer, and a store credit transfer. In some embodiments, the control circuit is further configured to charge the second customer for the item and issue a refund to the first customer in response to receiving the transaction confirmation. In some embodiments, the control circuit is further configured to select the plurality of potential buyers based on locations associated with the first customer and each of the plurality of customers. In some embodiments, the second customer is further selected based on one or more of recent purchases, estimated inventories, and budget constraints of each of the plurality of potential buyers. In some embodiments, the control circuit is further configured to recommend a transfer method, a meetup location, and/or a delivery agent based on customer profiles associated with the first customer and the second customer. In some embodiments, the control circuit is further configured to generate an item offer message for the first customer to send to the second customer, the item offer message being configured to emphasize selected characteristics of the item based on the customer profile associated with the second customer. In some embodiments, the item is offered to the second customer at a discounted price determined by the control circuit and/or the first customer.

In some embodiments, a method for handling return requests comprises receiving, at a control circuit and a communication device configured to communicate with a plurality of user devices, a request to return an item from a user device associated with a first customer, verifying, with the control circuit, that the request to return the item complies with return restrictions based on information stored in an order database, retrieving customer profiles of a plurality of potential buyers from a customer database storing customer profiles associated with a plurality of customers, determining, with the control circuit, alignments between the customer profiles of the plurality of potential buyers and product characteristics associated with the item stored in a product database storing characteristics associated with a plurality of products, selecting, with the control circuit, a second customer from the plurality of potential buyers based on the alignments, facilitating, with the control circuit, a transfer of the item from the first customer to the second customer, receiving, at a control circuit and via the communication device, a transaction confirmation for the transfer of the item, and providing, with the control circuit, a program incentive to the first customer in response to receiving the transaction confirmation.

In some embodiments, the customer profiles comprise customer value vectors, the customer value vectors each represents at least one of a person's values leading to at least one of a plurality of possible preferences and affinities and each comprises a magnitude that corresponds to the customer's belief in good that comes from an order associated with that value. In some embodiments, the method further comprises relaying messages between the first customer and the second customer. In some embodiments, the method further comprises facilitating a payment from the second customer to the first customer, the payment comprises one or more of an in-person payment, a peer-to-peer electronic payment transfer, a digital currency transfer, and a store credit transfer. In some embodiments, the method further comprises charging the second customer for the item and issuing a refund to the first customer in response to receiving the transaction confirmation. In some embodiments, the method further comprises selecting the plurality of potential buyers based on locations associated with the first customer and each of the plurality of customers. In some embodiments, the second customer is further selected based on one or more of recent purchases, estimated inventories, and budget constraints of each of the plurality of potential buyers. In some embodiments, the method further comprises recommending a transfer method, a meetup location, and/or a delivery agent based on customer profiles associated with the first customer and the second customer. In some embodiments, the method further comprises generating an item offer message for the first customer to send to the second customer, the item offer message being configured to emphasize selected characteristics of the item based on the customer profile associated with the second customer. In some embodiments, wherein the item is offered to the second customer at a discounted price determined by the control circuit and/or the first customer.

In some embodiments, an apparatus for handling return requests comprises a non-transitory storage medium storing a set of computer readable instructions, and a control circuit configured to execute the set of computer readable instructions which causes to the control circuit to receive, via a communication device configured to communicate with a plurality of user devices, a request to return an item from a user device associated with a first customer, verify that the request to return the item complies with return restrictions based on information stored in an order database, retrieve customer profiles of a plurality of potential buyers from a customer database storing customer profiles associated with a plurality of customers, determine alignments between the customer profile of the plurality of potential buyers and product characteristics associated with the item stored in a product database storing characteristics associated with a plurality of products, select a second customer from the plurality of potential buyers based on the alignments, facilitate a transfer of the item from the first customer to the second customer, receive, via the communication device, a transaction confirmation for the transfer of the item, and provide a program incentive to the first customer in response to receiving the transaction confirmation.

In some embodiments, a system for processing returns comprises a container housing comprising an access door to an item holding compartment, a return sensor configured to detect for returned items placed in the item holding compartment, a user interface device coupled to the container housing, a communication device configured to communicate with a customer database, and a control circuit coupled to the return sensor, the user interface device, and the communication device. The control circuit being configured to detect a returned item returned by a customer via the return sensor, present a feedback prompt via the user interface device, receive a customer response to the feedback prompt via the user interface device, and update, via the communication device, a customer profile associated with the customer in the customer database based on the customer response.

In some embodiments, the control circuit is further configured to retrieve, via the communication device, item characteristics associated with the returned item from a product database, retrieve, via the communication device, the customer profile associated with the customer from the customer database, select one or more relevant customer vectors from the customer profile based on comparing the customer vectors associated with the customer and the item characteristics associated with the returned item, and determine a content of the feedback prompt based on the one or more relevant customer vectors. In some embodiments, the customer vectors comprises customer value vectors, wherein the customer value vectors each represents at least one of a person's values leading to at least one of a plurality of possible preferences and affinities and each comprises a magnitude that corresponds to the customer's belief in good that comes from an order associated with that value. In some embodiments, the feedback prompt identifies at least one of the one or more relevant customer vectors and solicits a feedback related to the at least one of the one or more relevant customer vectors. In some embodiments, the control circuit is configured determine and communicate a plurality of feedback prompts each associated with at a different customer value. In some embodiments, the update to the customer profile comprises increasing a magnitude of a relevant customer vector or decreasing the magnitude of the relevant customer vector. In some embodiments, the update to the customer profile is further based on item characteristics of the returned item stored in a product database. In some embodiments, the user interface device comprises one or more of a display screen, a touch screen, a speaker, a microphone, and a motion sensor. In some embodiments, the container housing further comprises a locking mechanism for securing items in the item holding compartment. In some embodiments, the return sensor comprises one or more of a barcode scanner, an optically readable code scanner, a Radio Frequency Identification (RFID) reader, an optical sensor, an image sensor, and a weight sensor. In some embodiments, the control circuit is further configured to connect the customer with a remote customer care personnel via the user interface device and the communication device and provide the customer profile to the remote customer care personnel via a customer care personnel user interface.

In some embodiments, a method for processing returns comprises detecting, via a return sensor, that a returned item has been placed, by a customer, into an item holding compartment of a container housing comprising an access door, present a feedback prompt via a user interface device coupled to the container housing, receive a customer response to the feedback prompt via the user interface device, and update, via a communication device coupled to the user interface device, a customer profile associated with the customer stored in a customer database based on the customer response.

In some embodiments, the method further comprises retrieving, via the communication device, item characteristics associated with the returned item from a product database, retrieving, via the communication device, the customer profile associated with the customer from the customer database, selecting one or more relevant customer vectors from the customer profile based on comparing the customer vectors associated with the customer and the item characteristics associated with the returned item, and determining a content of the feedback prompt based on the one or more relevant customer vectors. In some embodiments, the customer vectors comprises customer value vectors, wherein the customer value vectors each represents at least one of a person's values leading to at least one of a plurality of possible preferences and affinities and each comprises a magnitude that corresponds to the customer's belief in good that comes from an order associated with that value. In some embodiments, the feedback prompt identifies at least one of the one or more relevant customer vectors and solicits a feedback related to the at least one of the one or more relevant customer vectors. In some embodiments, the method further comprises determining and communicating a plurality of feedback prompts each associated with at a different customer value. In some embodiments, the update to the customer profile comprises increasing a magnitude of a relevant customer vector or decreasing the magnitude of the relevant customer vector. In some embodiments, the update to the customer profile is further based on item characteristics of the returned item stored in a product database. In some embodiments, the user interface device comprises one or more of a display screen, a touch screen, a speaker, a microphone, and a motion sensor. In some embodiments, the container housing further comprises a locking mechanism for securing items in the item holding compartment. In some embodiments, the return sensor comprises one or more of a barcode scanner, an optically readable code scanner, a Radio Frequency Identification (RFID) reader, an optical sensor, an image sensor, and a weight sensor. In some embodiments, the method further comprises connecting the customer with a remote customer care personnel via the user interface device and the communication device and providing the customer profile to the remote customer care personnel via a customer care personnel user interface.

In some embodiments, a system for processing returns comprises a container housing comprising an access door to an item holding compartment, a return sensor configured to detect for returned items placed in the item holding compartment, a user interface device coupled to the container housing, a communication device configured to communicate with a product database and a customer vectors database, and a control circuit coupled to the return sensor, the user interface device, and the communication device. The control circuit being configured to identify a returned item returned by a customer via the return sensor, retrieve, via the communication device, item characteristics associated with the returned item from the product database, retrieve, via the communication device, customer vectors associated with the customer from the customer vectors database, select one or more relevant customer vectors from the customer vectors based on comparing the customer vectors associated with the customer and the item characteristics associated with the returned item, determine a message associated with the one or more relevant customer vectors, communicate the message to the customer via the user interface device, receive a customer response to the message via the user interface device, and update the customer vectors associated with the one or more relevant customer vectors in the customer vectors database based on the customer response.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. provisional applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; 62/486,801 filed Apr. 18, 2017; 62/510,322 filed May 24, 2017; 62/510,317 filed May 24, 2017; Ser. No. 15/606,602 filed May 26, 2017; 62/513,490 filed Jun. 1, 2017; and Ser. No. 15/624,030 filed Jun. 15, 2017.

What is claimed is:

1. A system for processing returns, comprising:
a customer profile database;
a communication device; and
a control circuit coupled to the customer profile database and the communication device, the control circuit being configured to:
receive, via the communication device, information on a return item being returned by a first customer associated with a delivery agent;
retrieve customer partiality vectors of a plurality of customers associated with the delivery agent from the customer profile database;
select a second customer from the plurality of customers based on partiality vectors of the second customer; and
instruct the delivery agent to reroute the return item from the first customer to the second customer.

2. The system of claim 1, wherein the customer partiality vectors each represents at least one of a person's values, preferences, affinities, and aspirations.

3. The system of claim 1, wherein the customer partiality vectors are determined from a purchase history of an associated customer.

4. The system of claim 1, wherein the delivery agent is instructed to reroute the return item from the first customer to the second customer without bringing the return item back to a retail, storage, distribution, or dispatch facility.

5. The system of claim 1, wherein the second customer is selected from customers on a delivery route of the delivery agent.

6. The system of claim 1, wherein the second customer is selected from customers who come after the first customer on a delivery route of the delivery agent.

7. The system of claim 1, wherein the second customer is selected by comparing the customer partiality vectors of the second customer with customer partiality vectors associated with the first customer.

8. The system of claim 1, wherein the second customer is selected by comparing the customer partiality vectors of the second customer with vectorized product characterizations associated with the return item.

9. The system of claim 1, wherein the control circuit is further configured to determine a delivery route for the delivery agent based on information on one or more return items being returned by one or more customers.

10. The system of claim 1, wherein the information on the return item being returned is received from one or more of a user device associated with the first customer, a portable device carried by the delivery agent, and a delivery receiving container.

11. A method for processing returns, comprising:
receiving, via a communication device coupled to a control circuit, information on a return item being returned by a first customer associated with a delivery agent;
retrieving customer partiality vectors of a plurality of customers associated with the delivery agent from a customer profile database;
selecting, with the control circuit, a second customer from the plurality of customers based on the customer partiality vectors of the second customer; and
instructing, with the control circuit, the delivery agent to reroute the return item from the first customer to the second customer.

12. The method of claim 11, wherein the customer partiality vectors each represents at least one of a person's values, preferences, affinities, and aspirations.

13. The method of claim 11, wherein the customer partiality vectors are determined from a purchase history of an associated customer.

14. The method of claim 11, wherein the delivery agent is instructed to reroute the return item from the first customer to the second customer without bringing the return item back to a retail, storage, distribution, or dispatch facility.

15. The method of claim 11, wherein the second customer is selected from customers on a delivery route of the delivery agent.

16. The method of claim 11, wherein the second customer is selected from customers who come after the first customer on a delivery route of the delivery agent.

17. The method of claim 11, wherein the second customer is selected by comparing the customer partiality vectors of the second customer with customer partiality vectors associated with the first customer.

18. The method of claim 11, wherein the second customer is selected by comparing the customer partiality vectors of the second customer with one or more vectorized product characterizations associated with the return item.

19. The method of claim 11, further comprising:
determining a delivery route for the delivery agent based on information on one or more return items being returned by one or more customers.

20. The method of claim 11, wherein the information on the return item being returned is received from one or more of a user device associated with the first customer, a portable device carried by the delivery agent, and a delivery receiving container.

21. An apparatus for processing returns comprising:
a non-transitory storage medium storing a set of computer readable instructions; and
a control circuit configured to execute the set of computer readable instructions which causes to the control circuit to:
receive, via a communication device coupled to the control circuit, information on a return item being returned by a first customer associated with a delivery agent;
retrieve customer partiality vectors of a plurality of customers associated with the delivery agent from a customer profile database;
select a second customer from the plurality of customers based on the customer partiality vectors of the second customer; and
instruct the delivery agent to reroute the return item from the first customer to the second customer.
